(19) United States
(12) Patent Application Publication
(10) Pub. No.: US 2021/0354508 A1
(43) Pub. Date: Nov. 18, 2021

(54) WHEEL ARRANGEMENT

(71) Applicant: Commonwealth Scientific and Industrial Research Organisation, Australian Capital Territory (AU)

(72) Inventors: Paul Damien FLICK, Australian Capital Territory (AU); Tim HOJNIK, Australian Capital Territory (AU)

(21) Appl. No.: 17/274,139

(22) PCT Filed: Sep. 6, 2019
(86) PCT No.: PCT/AU2019/050959

§ 371 Date: Mar. 5, 2021

(30) Foreign Application Priority Data
Sep. 7, 2018 (AU) 2018903349
Feb. 12, 2019 (AU) 2019900441

(51) Int. Cl. B60B 27/00; B60B 9/24; B60B 9/28

(52) U.S. Cl. CPC B60B 27/0068; B60B 9/24; B60B 2900/911; B60B 2900/551; B60B 2900/721; B60B 9/28

(57) ABSTRACT

A wheel including a substantially radially rigid rim; a hub for mounting the wheel to an axle; and, a plurality of actuators coupling the hub to the rim, the plurality of actuators being adjustable to control a hub position, the hub position being a position of the hub relative to the rim, and wherein at least some of the plurality of actuators act outside a plane of the rim.

### PRIORITY DOCUMENTS

The present application claims priority from Australian Provisional Application No. 2018903349 titled “WHEEL ARRANGEMENT” as filed on 7 Sep. 2018 and from Australian Provisional Application No. 2019900441 titled “WHEEL ARRANGEMENT” as filed on 12 Feb. 2019, the contents of which is hereby incorporated by reference in its entirety.

### BACKGROUND OF THE INVENTION

The present invention relates to a wheel, and in one particular example, to a wheel having a hub provided at a controllable hub position.

### DESCRIPTION OF THE PRIOR ART

The reference in this specification to any prior publication (or information derived from it), or to any matter which is known, is not, and should not be taken as an acknowledgment or admission or any form of suggestion that the prior publication (or information derived from it) or known matter forms part of the common general knowledge in the field of endeavour to which this specification relates.

Wheels provide an effective way to locomote a variety of platforms through unstructured environments while reducing surface slip to maximise efficiency. Robotic and automotive platforms commonly use pneumatic tyres due to their accessibility and minor suspension properties exhibited due to the underlying compressibility of air, compressed in a tube around their extremities. This combination therefore presents an attractive package and is subsequently used in a number of areas such as robotics and manned vehicles.

Other emerging approaches to locomotion over unstructured terrain are legged systems. Legged systems such as hexapods and other variants are able to traverse such terrain due to their extra degrees of freedom, when compared to a wheel. This allows for greater obstacles to be overcome for similarly sized systems, of wheeled equivalence. Legged systems attract uses from robotics for significant off-road uses, due to their exceptional mobility. However this requires complex control, and proves inefficient from the perspective of power consumption and time, compared to wheels.

A sweet-spot in efficiency and terrain traversability has been proposed with wheel-leg hybrids named ‘Whegs’. These whegs combine the simplicity and efficiency of wheels with the obstacle-clearing ability of legs. These systems are often complex and require a high level of control to maintain the desired contact with the chosen point on the ground.

As a wheeled vehicle's efficiency is highly dependent on the contact it makes with the ground, wheels continue to be the locomotion of choice for platforms performing a number of tasks. Wheels coupled with a suspension system allow desired operation to be maintained, as these mechanisms protect the vehicle chassis from mechanical vibrations, prolonging the vehicle's operational life.

Drive units, transmission and suspension systems have also been incorporated into wheels to increase the wheel efficiency while decreasing the overall system size. This proves efficient for high speed operations and requires low-level control as the suspension systems are passive. Subsequently this technology has mostly been adapted in the automotive sector for high speed vehicles and has seen limited use in the robotic and automation disciplines.

The limitations of such wheel-and-suspension systems aforementioned are most evidently demonstrated on non-smooth continuous and minor discontinuous surfaces. This terrain presents a difficulty in traversing which is generally overcome by increasing the wheel diameter, which in turn increases the overall size of the wheel. This is better combated for by legged systems as they can change shape and reach over obstacles that equally sized wheels cannot.

After a parallel investigation into wheels and suspension systems, most of the works are well suited to automotive vehicles, concerned with high speed and low relative travel. These systems are large and need to be shrunk to fit smaller robotic platforms and often forfeit their desired characteristics as the effects of gravity do not scale. Nevertheless, fundamental issues still exist in wheeled vehicle arrangements.

A number of attempts have been made to address these issues.

U.S. Pat. No. 6,357,770 describes a thin-profile wheel suspension system including spring and dampening mechanisms and an optional brake and drive motor, mounted to a suspension frame in a compact arrangement which permits all or most of the sprung components to be mounted within the volume enclosed by the rim of a wheel, and thus the wheel suspension of the invention may be referred to as an “in-wheel suspension”. The wheel suspension comprises a hub plate assembly including hub bearings and axle. The hub plate is mounted to a suspension frame by a motion-controlling sliding mount assembly, which connects the hub plate to the suspension frame while it permits the hub plate to slidably move in response to wheel loads. In the preferred embodiment, the suspension frame includes two forks, each fork mounting a sliding rail mount assembly comprising a slide-and-rail mechanism aligned vertically on the suspension frame and mounted to the hub plate. A spring mechanism such as a conventional piston-type shock absorber is mounted connecting to both the hub plate and the suspension frame to provide resilient motion control of the hub plate in response to vehicle weight, vehicle motion and road shock.

US20160068016 describes a wheel comprising a rim, a hub and a suspension unit. The wheel incorporates or is connectable to a torque source capable of producing torques up to a maximal torque for rotating the wheel around a rotation-axis. In this publication, the suspension unit includes at least one structural member, provided at least partially between the rim and the hub, configured to change in size and/or shape, relative to a nominal size and/or shape thereof, during displacements and/or rotations of the hub relative to a centre point of the rim. The suspension unit also includes at least one motion resisting component adapted to retain the structural member at the nominal size and/or shape thereof under torques smaller than the maximal torque.

U.S. Pat. No. 3,219,090 describes a resilient wheel comprising a one piece non-metallic body including a hub defining an axis of rotation, an integral rim having another rolling surface, and a large number of integral independent bendable spokes serving as the only means interconnecting said hub and said rim, all of said spokes extending at an angle to radii extending from said axis to said outer rolling surface whereby said spokes bend as cantilevers when load is applied to flatten said wheel.

U.S. Pat. No. 7,017,687 relates to a reconfigurable leg and wheel device including an array of components joined in series configurable as i) an articulated leg with the components movable with respect to one another in a walking motion, and reconfigurable as ii) a wheel with the components forming a circular outer surface and being rotatable about an axis in a rotational motion.

US20130081885 relates to a personal mobility device for transporting a person over different surfaces and obstacles. This publication comprises technology that can be used for next-generation motorized wheelchairs that enable people to travel outside during winter months, to go “off-road,” and to travel up and down staircases independently. This publication features shape-changing wheels that change shape to travel more effectively on different surfaces and obstacles. The shape of a shape-changing wheel is changed by the motorized rotation of at least two rotating members that are part of the shape-changing wheel. Rotation of these rotating members into a first configuration causes the ground-contacting perimeter of the wheel to be circular. Rotation of these rotating members into a second configuration causes the ground-contacting perimeter of the wheel to be non-circular.

U.S. Pat. No. 5,492,390 relates to a variable shaped wheel having a hub, a plurality of extendable ram rods connecting the hub and shape adaptable rim. Extension and retraction of the ram rods cause the rim to harmonize to a selected wheel shape such as horizontal oval, vertical oval, elliptical, tractor like and numerous other shapes, when stationary and while moving. The selected shape of the variable wheel in motion is maintained by continual length adjustment of the ram rods. The variable shaped wheel adjusts to the most effective, efficient shape for travel over varying surfaces such as asphalt, concrete, sand, mud, rock, snow, ice and others, providing optimum speed and comfort. It is another purpose of the publication, through change in shape of the variable wheel, pulley, gear from conventional circular to oval, elliptical, and shapes other than circular, to make contact at the periphery along the elongated axis with another wheel, pulley, gear, providing for simple and effective rotational energy transmission from one wheel, pulley, gear, to another.

US20170349003 describes a wheel with an intelligent suspension system that includes a hub, a rim and a set of spokes with dynamically adjustable spoke lengths. Furthermore, it includes one or more sensors associated with at least the hub and the rim and a microcontroller unit (MCU) that receives sensory signals from the one or more sensors, and transmits control signals to the set of spokes to dynamically control spoke lengths of the set of spokes.

U.S. Pat. No. 3,672,458 relates to a self-propelled driver wheel for a vehicle comprising a plurality of linearly expandable spokes uniformly arranged about a central hub, each spoke being separately joined to a supply of fluid under pressure and being provided with distributor means for selectively distributing the fluid to the spokes whereby on expansion thereof the wheel is caused to turn.

US20170151830 describes a wheel including an outer wheel ring, a hub at least one support device supporting the outer wheel ring on the hub, and an adjustment device configured to adjust the hub relative to the outer wheel ring, wherein the support device has multiple support elements which extend between the hub and the wheel ring, and wherein the support elements are arranged three-dimensionally such that the hub can be adjusted in five degrees of freedom relative to the outer wheel ring.

DE19957373 relates to a wheel having a tyre defining a central wheel axis and a wheel hub displaceable relative to the central axis. The hub is connected to the tyre by means to form an active spoke. An energy accumulator supplies or withdraws shear energy to and from each active spoke which is controlled by a control device to allow a torque to be produced continuously on the wheel with an eccentric position of the hub. There are preferably three straight line active spokes whose first ends are fitted for swivel movement at uniform circumferential spacing on the tyre and whose second ends are connected to the hub. The length of the spokes can be varied so that the hub has a controllable distance from the wheel axis.

### SUMMARY OF THE PRESENT INVENTION

In one broad form, an aspect of the present invention seeks to provide a wheel including: a substantially radially rigid rim; a hub for mounting the wheel to an axle; and, a plurality of actuators coupling the hub to the rim, the plurality of actuators being adjustable to control a hub position, the hub position being a position of the hub relative to the rim, and wherein at least some of the plurality of actuators act outside a plane of the rim.

In one embodiment, the actuators include a first hub end coupled to the hub and a second rim end coupled to the rim, and wherein the at least some of the actuators include at least one of: hub ends spaced in an axial direction, the axial direction being parallel to the axle; and, rim ends spaced in the axial direction.

In one embodiment, the actuators include a plurality of first actuators and a plurality of second actuators, wherein the first and second actuators have hub ends spaced in an axial direction.

In one embodiment, the wheel includes a hub extending in an axial direction and wherein the actuators are coupled to the hub so that hub ends of at least some of the actuators are spaced in an axial direction.

In one embodiment, the wheel includes two hubs connected to the rim relatively parallel to one another.

In one embodiment, each hub is connected to three actuators.

In one embodiment, the one or more actuators are pivotally mounted to the hub and the rim.

In one embodiment, the one or more actuators are pivotally mounted to the hub and the rim using ball and socket joints.

In one embodiment, each actuator includes a linear actuator having a housing and an arm linearly movable relative to the housing to allow a length of the linear actuator to be adjusted.

In one embodiment, the housing includes a piston chamber and the arm is mounted to a piston movably mounted within the piston chamber to thereby adjust a length of the actuator.

In one embodiment, each actuator further comprises a valve for controlling fluid flow into and out of the piston chamber to thereby adjust the length of the actuator.

In one embodiment, the valve is a solenoid valve.

In one embodiment, each actuator includes: a sensor that measures an actuator arm position; and, an actuator controller that controls the actuator in accordance with signals from the sensor and instructions from a control system.

In one embodiment, the actuator controller: uses signals from the sensor to determine a current actuator length; and, controls the actuator in accordance with the current actuator length and a target actuator length.

In one embodiment, the sensor includes a magnet mounted to an arm and an array of Hall effect sensors mounted to a housing, for determining an arm position of the arm relative to the housing, thereby allowing the actuator length to be measured.

In one embodiment, the one or more actuators are electronic linear actuators and the sensor includes an encoder.

In one embodiment, the one or more actuators are mounted to the hub offset from the centre of the hub.

In one embodiment, the one or more actuators extend from the hub to the rim at angle offset to a radial direction.

In one embodiment, the one or more actuators are pivotally mounted to the hub and the rim.

In one embodiment, the wheel includes three actuators.

In one embodiment, the wheel includes a plurality of actuators evenly circumferentially spaced around the rim.

In one embodiment, the hub position includes at least one of: a position in a plane of the rim; a position offset from the plane of the rim; and, a rotation of the hub relative to a plane of the rim.

In one broad form, an aspect of the present invention seeks to provide a wheel including: a substantially radially rigid rim; a hub for mounting the wheel to an axle; and, a one or more actuators coupling the hub to the rim, the one or more actuators being adjustable to control a hub position, the hub position being a position of the hub relative to the rim.

In one embodiment, each actuator includes a linear actuator having a housing and an arm linearly movable relative to the housing to allow a length of the linear actuator to be adjusted.

In one embodiment, the housing includes a piston chamber and the arm is mounted to a piston movably mounted within the piston chamber to thereby adjust a length of the actuator.

In one embodiment, each actuator further comprises a valve for controlling fluid flow into and out of the piston chamber to thereby adjust the length of the actuator.

In one embodiment, the valve is a solenoid valve.

In one embodiment, each actuator includes: a sensor that measures an actuator arm position; and, an actuator controller that controls the actuator in accordance with signals from the sensor and instructions from a control system.

In one embodiment, the actuator controller: uses signals from the sensor to determine a current actuator length; and, controls the actuator in accordance with the current actuator length and a target actuator length.

In one embodiment, the sensor includes a magnet mounted to an arm and an array of Hall effect sensors mounted to a housing, for determining an arm position of the arm relative to the housing, thereby allowing the actuator length to be measured.

In one embodiment, the one or more actuators are electronic linear actuators and the sensor includes an encoder.

In one embodiment, the one or more actuators are mounted to the hub offset from the centre of the hub.

In one embodiment, the one or more actuators extend from the hub to the rim at angle offset to a radial direction.

In one embodiment, the one or more actuators are pivotally mounted to the hub and the rim.

In one embodiment, the one or more actuators are provided in a plane of the rim.

In one embodiment, at least some of the actuators act in a direction are coupled to the hub offset from a plane of the rim.

In one embodiment, the wheel includes three actuators.

In one embodiment, the wheel includes a plurality of actuators evenly circumferentially spaced around the rim.

In one embodiment, the hub position includes at least one of: a position in a plane of the rim; a position offset from the plane of the rim; and, a rotation of the hub relative to a plane of the rim.

In another broad form, an aspect of the present invention seeks to provide a control system for controlling a wheel, the wheel including: a substantially radially rigid rim; a hub for mounting the wheel to an axle; and, one or more actuators coupling the hub to the rim, the actuators being adjustable to control a hub position, the hub position being a position of the hub relative to the rim, and wherein the control system includes one or more electronic processing devices configured to: determine a target hub position; calculate a target actuator length for each actuator in accordance with the target hub position; and, control each actuator in accordance with the target actuator length.

In one embodiment, the one or more electronic processing devices: generate control instructions for each actuator controller of each actuator in accordance with the target actuator length; and, provide the control instructions to the actuator controllers to thereby control the actuators.

In one embodiment, the one or more electronic processing devices: determine a wheel orientation; and, use the wheel orientation to calculate at least one of: a target hub position; and, one or more target actuator lengths.

In one embodiment, the one or more electronic processing devices: determine a wheel rotational movement; and, use the wheel rotational movement to calculate at least one of: a target hub position; and, target actuator lengths.

In one embodiment, the one or more electronic processing devices: receive signals from a wheel sensor; and, use signals from the wheel sensor to determine at least one of: wheel rotational movement; and, a wheel orientation.

In one embodiment, the one or more electronic processing devices: determine a wheel hub position in a wheel frame of reference; and, calculate the target hub position using the wheel hub position and at least one of: wheel rotational movement; and, a wheel orientation.

In one embodiment, the one or more electronic processing devices: determine an action to be performed; and, determine the wheel hub position in accordance with the action.

In one embodiment, the action is one of: manoeuvring the wheel; changing a gear ratio of the wheel; changing a vehicle ride height; lifting a wheel; hopping a wheel; steering the wheel rim; motor-less wheel motion; providing shock absorption; and, providing active suspension.

In one embodiment, the one or more electronic processing devices: detect a force on the wheel using a force sensor; and, determine the target hub position in accordance with the detected force to thereby mitigate the effect of the force.

In one embodiment, the one or more electronic processing devices determine the current hub position by using signals from sensors to determine a current actuator length of each actuator.

In one embodiment, the one or more processing devices: receive a current actuator length from an actuator controller; and, calculate a current hub position using the current actuator length of each actuator.

In another broad form, an aspect of the present invention seeks to provide a method for controlling a wheel, the wheel including: a substantially radially rigid rim; a hub for mounting the wheel to an axle; and, one or more actuators coupling the hub to the rim, the one or more actuators being adjustable to control a hub position, the hub position being a position of the hub relative to the rim, and wherein the method includes, in one or more electronic processing devices: determining a target hub position; calculating a target actuator length for each actuator in accordance with the target hub position; and, controlling each actuator in accordance with the target actuator length.

It will be appreciated that the broad forms of the invention and their respective features can be used in conjunction, interchangeably and/or independently, and reference to separate broad forms is not intended to be limiting.

### BRIEF DESCRIPTION OF THE DRAWINGS

Various examples and embodiments of the present invention will now be described with reference to the accompanying drawings, in which:

FIG. 1 is a schematic diagram of an example of a wheel;

FIG. 2 is a flow chart of an example of a process for controlling a wheel;

FIGS. 3A to 3D are schematic diagrams illustrating movement of the wheel hub;

FIG. 4 is a schematic diagram of an example of a control system;

FIG. 5 is a flow chart of a specific example of a process for controlling a wheel;

FIG. 6 is a schematic front view of an example of a coordinate system for a wheel;

FIG. 7 is a schematic top view of the coordinate system of FIG. 5;

FIGS. 8A to 8C are schematic front views of the wheel of FIG. 1 with the hubs in different positions;

FIGS. 9A to 9D are graphs illustrating different hub movements for the wheel of FIG. 1;

FIGS. 10A to 10C are graphs illustrating different actuator movements for the wheel of FIG. 1;

FIGS. 11A to 11D are images illustrating rotation of a wheel with hubs in different positions to simulate maintaining a fixed vehicle ride height with respect to the ground;

FIG. 12 is a graph illustrating actuator and hub positions for the wheel shown in FIGS. 11A to 11D;

FIGS. 13A and 13B are schematic diagrams of an example of a vehicle incorporating the wheel of FIG. 1;

FIGS. 14A to 14C are schematic diagrams illustrating movement of a hub relative to a rim of a wheel;

FIGS. 15A to 15C are schematic diagrams illustrating movement of a hub relative to a rim of a wheel;

FIGS. 16A to 16C are schematic diagrams illustrating movement of a hub relative to a rim of a wheel;

FIGS. 17A to 17D are schematic diagrams of an example of a wheel with two hubs;

FIGS. 18A to 18D are schematic diagrams of an example of a vehicle incorporating the wheel of FIG. 17;

FIGS. 19A to 19D are schematic diagrams of an example of a vehicle;

FIG. 20 is a schematic diagram illustrating movement of a wheel;

FIG. 21 is an image an example of a two-wheel vehicle;

FIG. 22 is a schematic front view of an example of a coordinate system for a wheel;

FIG. 23A is a graph illustrating hub workspace for a wheel;

FIG. 23B is a graph illustrating potential torque in the workspace of FIG. 23A;

FIG. 23C is a graph illustrating slope angle able to climb for varying radius change wheels;

FIGS. 24A to 24D are graphs illustrating wheel rotation in various slope degrees;

FIG. 25 is a graph illustrating data recorded of the wheel; and,

FIGS. 26(a) to 26(e) are schematic diagrams illustrating normal rolling gait.

### DETAILED DESCRIPTION OF THE PREFERRED EMBODIMENTS

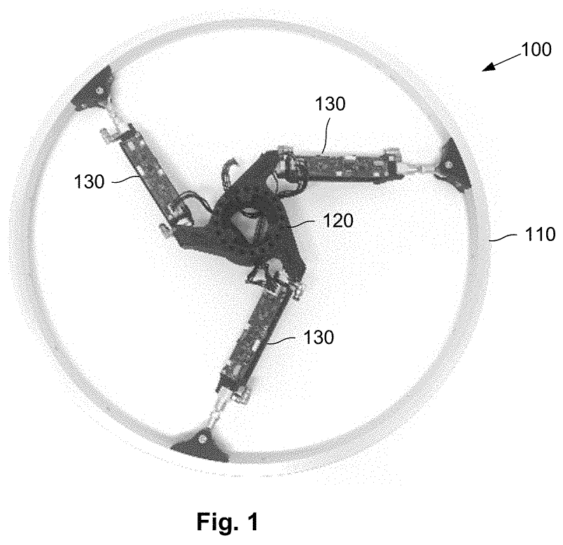

An example of a wheel will now be described with reference to FIG. 1.

In this example, the wheel 100 includes a substantially radially rigid rim 110. The nature of the rim will vary depending on the preferred implementation, and could include a resilient plastic, rubber, metal, or other similar material, formulated and/or configured so that the rim has a substantially constant size and shape. In this regard, the term substantially rigid and substantially constant size and shape will be understood to mean that the wheel rim does not deform substantially in a radial direction under stresses or forces the wheel rim would normally be expected to endure, but should not exclude deformation occurring under undue stress. It should also be noted that the rigidity of the rim could arise from inherent material properties of the rim and/or the presence of supporting structures such as spokes, or the like.

The rim 110 can be similar to an existing wheel rim, and may support an external member, including a non-rigid or semi-rigid member, such as a tyre or other similar arrangement, depending on the intended application of the wheel. The rim can be circular in shape, in which case it will typically have a substantially fixed radius, although this is not necessarily essential and non-circular rims, such as oval rims could be used, depending on the intended application. In this instance, whilst the radius of the rim varies around the circumference of the rim, the radius would be fixed in the sense it does not vary in use.

The wheel 100 further includes a hub 120 provided within the rim 110 for mounting the wheel 100 to an axle (not shown). The hub can be fixed to the axle, allowing the wheel to be driven by the axle, or could be rotatably mounted to the axle, allowing the wheel to rotate freely, or be driven by another drive mechanism, such as a sprocket and chain arrangement.

The hub 120 acts to support at least one actuator 130, which couples the rim 110 and the hub 120. The nature of the actuators will depend on the preferred implementation and could include linear actuators, such as electric, pneumatic or hydraulic actuators, non-linear actuators, or the like. In this example three actuators are shown, which allow for full manoeuvrability and support of the hub relative to the rim. It will be appreciated that smaller number of actuators could be used, such as one or two actuators. In this instance, these would typically be used in conjunction with other supporting elements, such as passive pneumatic pistons, or other similar arrangements, to allow the rim to be supported whilst the hub undergoes movement. In this instance, the range of movement may be limited compared to scenarios in which three actuators are used. Additionally, it is also possible to use larger numbers of actuators, for example to provide for increased robustness, or redundancy, or to increase the weight bearing capability of the wheel.

For the purpose of ease of illustration the following description will focus on the use of a plurality of actuators, and primarily three actuators, but it will be appreciated that some of the techniques could also be applied to arrangements including less actuators.

In use, controlling the actuators 130, and in particular selectively controlling the length of each actuator 130, allows the hub 120 to be moved relative to the wheel rim 110 thereby allowing a hub position to be controlled, which in turn can be used for a number of purposes.

For example, in the event that the wheel is driven, this can be used to actively change the height of the hub relative to the ground, which can in turn be used to adjust a vehicle ride height. Similarly, this can be used to raise or lower a wheel, thereby providing active suspension, which can assist in navigating obstacles. Adjusting the vehicle height can also assist in changing the gear ratio of the vehicle, by altering the effective size of the wheel, as will be described in more detail below.

In addition to vertically offsetting the hub, the hub can also be moved laterally, which can be used to change the wheel based on the vehicle, for example to increase or decrease the wheelbase by moving wheels forwards and backwards. Alternatively, in an example in which the wheel freely rotates relative to the axle, offsetting the hub position laterally within a plane of the rim can be used to cause the wheel to rotate by offsetting the vehicle's centre of gravity, which in turn can be used to drive a vehicle.

In the event that the actuators are able to act in a direction offset from a plane of the rim, for example if the actuators are non-linear and/or include one end positioned offset from a plane of the rim, this can be used to move some or all of the rim laterally, which in turn can be used to offset the rim and hub and/or to rotate the rim relative to the hub, thereby effectively steering the wheel. It should also be noted that steering of a vehicle could be achieved by using a differential ride height on different sides of the vehicle, for example by alter the gear ratios on each side, and hence the distance each side of the vehicle travels for a given wheel rotation rate.

The actuators can also be used to provide shock absorber functionality. In one example, this is achieved passively, based on inherent compliance within the actuators, but additionally and/or alternatively, this could be performed actively, by detecting impacts of the wheels with obstacles, or the environment, and then controlling the actuators to absorb the impact.

Finally, rapid movement of the hub relative to the rim can be used to cause movement of the vehicle, for example temporarily lifting the wheel from the ground surface, to allow for jumping, hopping, or other similar actions, which can be useful to dislodge a wheel or vehicle if it becomes stuck against an obstacle.

Accordingly, it will be appreciated that the above described arrangement can provide a wheel with vastly increased functionality. This is particularly useful in a wide range of applications, such as on autonomous vehicles or rovers, as this enables the vehicle to cope with a far wider range of terrain than would otherwise be the case, whilst maintaining a simple lightweight configuration, and/or providing improved efficiency.

A number of further features will now be described.

As mentioned above, any form of actuator can be used, but in one preferred example, each actuator is a linear actuator, which typically includes a housing and an arm. The arm is configured to move linearly relative to the housing to allow a length of the linear actuator to be adjusted. Using linear actuators allows the hub position to be easily controlled without increasing the wheel in size. Linear actuators are also generally lightweight and robust, which is advantageous for small vehicles and/or rough terrain conditions.

In one example, the linear actuator can be a pneumatic or hydraulic actuator. The housing may include a piston chamber, with the arm being mounted to a piston movably mounted within the piston chamber, to thereby adjust a length of the actuator as the piston moves within the piston chamber. A pneumatic or hydraulic actuator is also light in weight and cost-effective to run, whilst pneumatic arrangements have an additional benefit of having a degree of inbuilt compliance, enabling this to provide an inherent suspension and/or shock absorber effect. In this regard, it will be appreciated that such shock absorption will be provided in any direction within the plane of the wheel, meaning that shocks in a forward and rearward directions are absorbed, as well as shocks in up and down directions, thereby accommodating shocks if the wheel impacts an object, such as a wall, which is not case with current shock absorber arrangements. Additionally, the compliance can also assist in accommodating slight inaccuracies in control, for example if the timing of one of the actuators is offset from the other actuators. It will be appreciated however that alternatively electric drive actuators could be used.

The actuator may further comprise a valve to control a fluid flow, such as air or hydraulic fluid flow, into and out of the piston chamber to thereby adjust the length of the actuator. The valve can be a solenoid valve or other suitable valve arrangements capable of controlling the fluid flow, and it will be further appreciated that pumping or other mechanisms for inducing fluid flow will also typically be provided to allow flow to occur once the valves are open.

In one example, each actuator includes a sensor that measures an actuator arm position and an actuator controller that controls the actuator in accordance with signals from the sensor and instructions from a control system. Measurement of the actuator arm position can be used in order to determine a current actuator length, which in turn can be used to derive the hub position relative to the rim, as well as controlling the actuators to allow a desired actuator length to be achieved.

Thus, for example, the actuator controller can use signals from the sensor to determine a current actuator length and control the actuator in accordance with the current actuator length and a target actuator length.

Whilst any form of sensor could be used, in one example, the sensor includes a magnet mounted to an arm and an array of Hall effect sensors mounted to, and typically extending along the actuator housing. A Hall effect sensor is a transducer that varies its output voltage in response to a magnetic field, so that as the magnet moves along the array, the sensors can use differential voltages generated within each Hall effect sensor to determine an arm position relative to the housing. This provides a robust lightweight sensor that allows an arm position, and hence actuator length, to be accurately measured.

In another example, the actuators are electronic linear actuators, in which case Hall effect sensors are not required, and the sensor could include a rotational encoder, or other suitable sensor.

In one example, the actuators are mounted to the hub offset from the centre of the hub, and specifically with the actuators extending from the hub to the rim at angle offset to a radial direction. This allows the wheel diameter to remain small, whilst allowing the stroke length of each actuator to be increased as compared to mounting each actuator at a point coaxial with the axle. However, it will be appreciated that such coaxial mounting arrangements are not excluded.

The actuators are typically pivotally mounted to the hub and rim, to allow for movement in a plane parallel to a plane of the wheel, to thereby accommodate changes in relative orientation arising from changes in the actuator length. It will be appreciated that this may not be required, for example in the event that the actuators are radially aligned.

In one example, the actuators are provided in a plane of the rim, in which movement of the hub is typically constrained so that the hub positions are within the plane of the rim. However, this is not essential, and additionally and/or alternatively, at least some of the actuators can be coupled to the hub offset from a plane of the rim, or otherwise arranged to act in a direction offset to a plane of the rim. This allows a greater range of hub movement to be achieved, for example allowing the hub position to be offset from the plane of the rim, effectively moving the rim laterally relative to the hub, or rotating the hub relative to a plane of the rim, which in turn can be used to steer the wheel.

In one example, the wheel includes three actuators, which provides good stability and a full range of control over the hub position. However, this is not essential and alternatively other numbers of actuators could be used. Where multiple actuators are used, these are preferably evenly circumferentially spaced around the rim, to provide for even weight distribution and balanced control over the hub position.

In order for the wheel to function a control system can be provided, which typically includes one or more electronic processing devices. The processing devices can be of any appropriate form, and could form part of one or more processing systems, such as computer systems, servers, or the like. For ease of illustration the remaining description will refer to a processing device, but it will be appreciated that multiple processing devices could be used, with processing distributed between the devices as needed, and that reference to the singular encompasses the plural arrangement and vice versa.

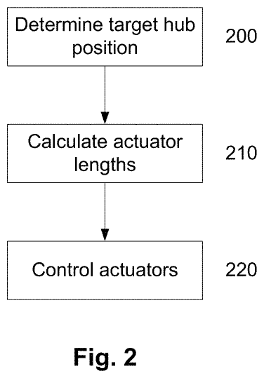

Operation of the wheel and the control system will now be described with reference to FIG. 2.

At step 200, a target hub position relative to the rim 110 is determined. This can be performed in any one of a number of manners, depending on the preferred implementation. For example, this could be based on user input commands. More typically however this is performed in order to allow an action to be performed, such as manoeuvring the wheel 100, changing a ride height or a gear ratio of the wheel, providing suspension to the wheel 100, offsetting the wheel to induce drive, rotating the hub relative to a plane of the rim to provide steering, or the like. For example, if the target hub position is defined to be in an upper quadrant of the rim 110, this allows the hub 120 to be raised relative to the wheel rim, thereby either raising a vehicle and/or lowering the wheel. This will also alter the effective gear ratio of the vehicle by altering the effective size of the wheel, given that the effective size is governed by the wheel radius at the point of contact with the ground. For example, raising the ride height will increase the radius at the point of contact with the ground, which increases the linear velocity of the outer rim at the point of contact, for a given rotational rate.

At step 210, the control system calculates a target actuator length for each actuator in accordance with the target hub position. Thus, this involves calculating the length of each actuator required to position the hub at the respective target hub position.

At step 220, the plurality of actuators 130 that couple the rim 110 and the hub 120 are controlled according to the target actuator lengths, to thereby move the hub 120 to the target hub position.

Accordingly, the above described control process allows the position of the hub 120 to be adjusted, thereby enabling the functionality described previously to be implemented. In one particular example, this can be achieved using a control system that can control each of the actuators, which in turn allows desired actions to be achieved.

In one example the control system communicates with each actuator controller, using the actuator controllers to control the operation of each actuator, whilst the control system provides overall control, for example to coordinate the operation of a number of wheels. This is achieved by having the control system generate a control instruction, which is provided to the actuator controller of each actuator, to allow the actuator to be controlled in accordance with the target actuator length. This arrangement is particularly beneficial in simplifying control processes and minimising latency, as will be described in more detail below.

To be able to determine the target hub position and control the actuators, the control system typically requires information regarding the position of each actuator relative to the hub and rim. For example, if the hub is to be raised, the control system needs to understand the current orientation of the wheel rim 110 and actuators 130, to allow the target hub position and/or associated actuator lengths to be calculated.

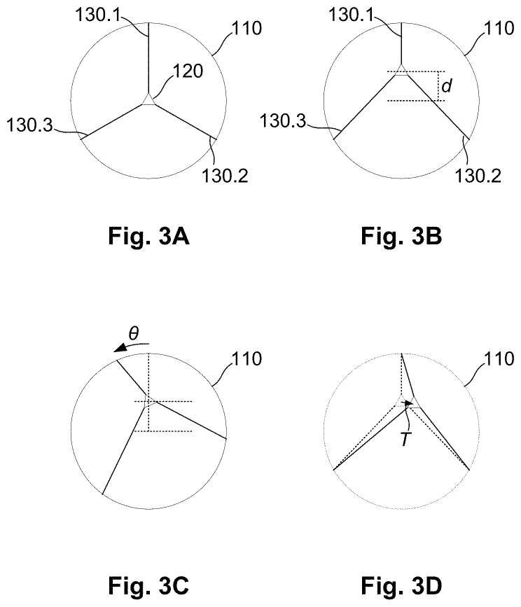

An example of this is shown in FIGS. 3A and 3B, which shows the operation of raising the hub by a distance d to thereby increase the ride height of the vehicle, which in this instance results in a shortening of the actuator 130.1 and lengthening of actuators 130.2, 103.3.

As the actuators are attached to the hub and rim at fixed positions, the one or more electronic processing devices can determine the relative actuator positions by determining a wheel orientation and then using the wheel orientation determine target actuator lengths.

In addition, as the wheel is typically undergoing movement, and in particular rotation, this may also need to be taken into account when calculating the actuator lengths needed to achieve or maintain a desired hub position, specifically to accommodate the fact that the actuators will have moved between the actuator length being measured and the target position calculated.

An example of this is shown in FIGS. 3C and 3D. In this regard, FIG. 3C shows the configuration of the wheel if the hub ride height d is to be maintained while the wheel rotates through an angle θ. FIG. 3D shows a comparison of the wheel configurations of FIGS. 3C and 3D, highlighting that the hub position undergoes a translation T, in order for the ride of the wheel to be maintained as the wheel rotates. This in turn leads to an increase in length of the actuators 130.1, 130.3 and shortening of the actuator 130.2.

In particular, as the control process will take a finite amount of time to implement, the system may need to calculate a target hub position and/or target actuator lengths based on a wheel rotational movement, so that the resulting hub position is correct by the time the control has been affected.

In this regard, it will be appreciated that the wheel position and/or rotational movement can be determined in any one of a number of ways, including by using a wheel sensor that senses a rotational position of the wheel, with changes in position being used to derive a rotational rate.

In one example, the control system determines a wheel hub position, which corresponds to a wheel hub position in a wheel frame of reference (which is static upon rotation of the wheel), so for example corresponding to a target ride height. The control system then transforms this into a target hub position in a rim frame of reference (which rotates as the wheel rotates) using the wheel movement and/or orientation, allowing the target hub position to be defined relative to the rim. This then simplifies the calculation of the target actuator length, and allows the actuator lengths to be controlled.

In one example, the one or more electronic processing devices operate by determining an action to be performed and then calculating a wheel hub position in accordance with the action to be performed. This allows an external control system, such as a vehicle controller, to specify an action to be performed, allowing this command to be transformed into a one or more target hub positions, which can then be used to calculate target actuators lengths, which can then be used by the actuator controllers to control the actuators.

Examples of the actions that can be performed include, but are not limited to manoeuvring the wheel, changing a gear ratio of the wheel, changing a vehicle ride height, lifting a wheel, providing shock absorption or providing active suspension.

As mentioned above, depending on the configuration of the actuators, the wheel can incorporate passive shock absorption functionality. However, additionally and/or alternatively activate shock absorption can be performed. For example, in the event that a vehicle strikes an object, such as a wall or kerb, the force on the wheel can be detected, and the hub moved to reduce the stress on the vehicle. Thus, the hub could be moved towards the object, and progressively slowed, to thereby reduce the transmission of force to the vehicle. In order to achieve this, the control system can be configured to detect a force, such as an impact on the wheel, using a force sensor, such as an accelerometer or similar. The control system can then determine the target hub position in accordance with the detected force to thereby mitigate the effect of the force.

In one example, control the actuator can be achieved by providing an instruction corresponding to a change in actuator length. This requires an understanding of the current length of the actuator, which can be useful in compensating for the fact that the actual actuator length may deviate from a target length. In this example, the control system can determine a current hub position relative to the rim using signals from sensors on the actuators, and using this to calculate the hub position. In one example, this is achieved by receiving a current actuator length from the actuator controller, which determines this based on a signals from respective Hall effect sensors, as described above.

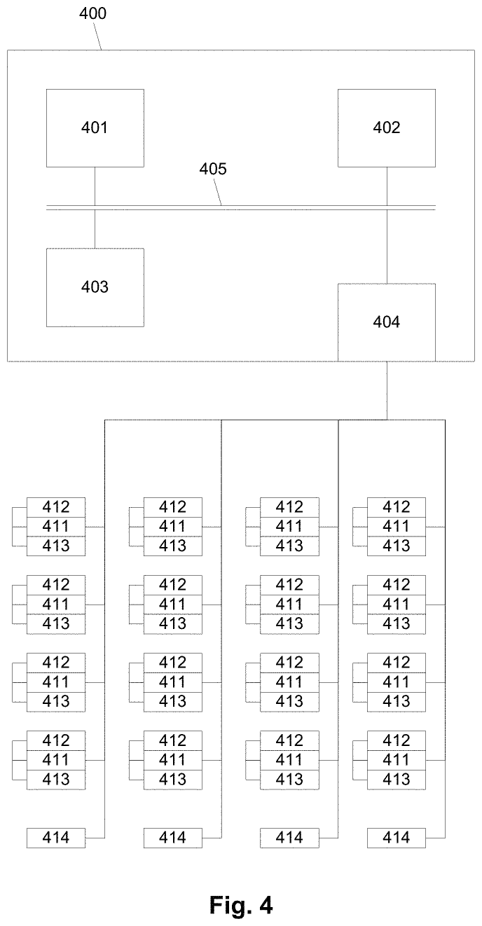

An example control system will now be described with reference to FIG. 4. For the purpose of this example, it is assumed that the control system forms part of a vehicle having four wheels 100, with each wheel including three actuators 130.

In this example, the control system includes at least one microprocessor or microcontroller 401, a memory 402, an optional input/output device 403, such as a keyboard and/or display, and an interface 404, interconnected via a bus 405 as shown. In this example the interface 404 can be utilised for connecting the control system 400 to actuator controllers 411, associated with each actuator of each wheel, which are in turn connected to sensors 412 and actuator control valves 413, allowing the length of each actuator to be measured and adjusted. The control system 400 is also connected to wheel orientation sensors 414, allowing the orientation of each wheel to be measured, and optionally to another control system, such as a vehicle autopilot or similar (not shown). Although a single external interface 403 is shown, this is for the purpose of example only, and in practice multiple interfaces using various methods (e.g. Ethernet, serial, USB, wireless or the like) may be provided.

In use, the microcontroller 401 executes instructions in the form of applications software stored in the memory 402 to allow the required processes to be performed. The applications software may include one or more software modules, and may be executed in a suitable execution environment, such as an operating system environment, or the like.

Accordingly, it will be appreciated that the control system 400 may be formed from any suitable processing system, such as a suitably programmed client device, PC, web server, network server, or the like. In one particular example, the control system 400 is a standard processing system such as an Intel Architecture based processing system, which executes software applications stored on non-volatile (e.g., hard disk) storage, although this is not essential. However, it will also be understood that the processing system could be any electronic processing device such as a microcontroller, microchip processor, logic gate configuration, firmware optionally associated with implementing logic such as an FPGA (Field Programmable Gate Array), or any other electronic device, system or arrangement.

In any event, it will be appreciated that this provides a division of processing between the actuator controllers 411 and the control system 400, with the control system being responsible for calculating the target actuator lengths, and with control of the actuators being performed by the individual actuator controllers 411. This allows the actuator controllers 411 to be formed from simple circuitry, so that these can be mounted on the actuators. This in turn allows these to be directly coupled to the control valves 413 and sensors 412, minimising control latency. Meanwhile the complex calculation of the required actuator lengths for all actuators can be performed centrally, using a high powered processing arrangement, minimising calculation time and ensuring calculation of lengths is synchronised for all wheels, thereby helping maintain effective control of the vehicle and hence wheels.

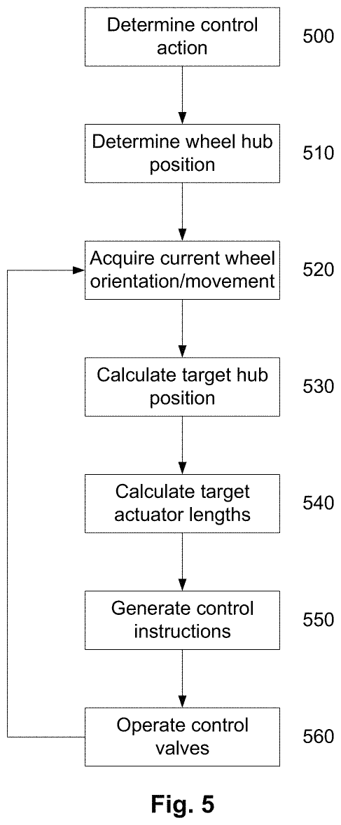

An example of the operation of the control system will now be described in more detail with reference to FIG. 5. For the purpose of this example, it is assumed that processes performed by the control system 400 are performed by the processor 401 in accordance with instructions stored as applications software in the memory 402 and/or input commands received from a user via the I/O device 403, or commands received via the interface 304.

In this example, at step 500, the control system 400 determines an action to be performed, such as to raise the vehicle ride height or similar. At step 510, the control system calculates a wheel hub position in a wheel frame of reference, which is invariant upon rotation of the wheel, so for example determining the hub should be raised by a distance d.

At step 520 the control system 400 determines a current wheel orientation and movement, using the wheel orientation sensor 414 and uses this and the wheel hub position, to transform the wheel hub into a rim frame of reference (which rotates as the wheel rotates) to thereby calculate a hub target position at step 530. This can be based on the current orientation of the wheel, but can also take into account system latency and movement of the wheel to predict the required target hub position when the control operation has been completed.

The target hub position is then used to calculate actuator target lengths at step 540, with the target lengths being used to generate control instructions at step 550, which are transferred to the respective actuator controllers 411, allowing the control valves 413 to be operated so that the actuator lengths are adjusted as required at step 560.

A specific example of the wheel is described below in detail. It will be appreciated that the described configuration is for exemplary purpose, and numerous other configurations may be used.

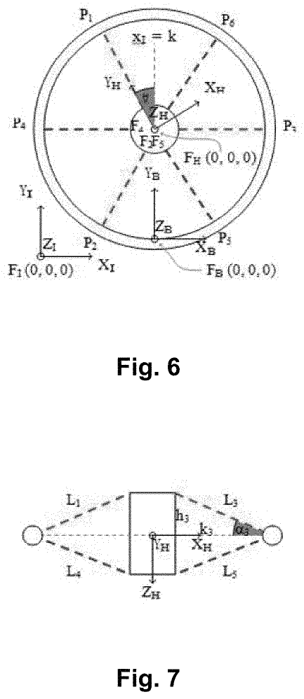

For the mathematical modelling of the system proposed in this example, three major frames of reference are used. These are represented using the Cartesian coordinate system using matrix notation. Referring to FIG. 6, the first frame is the inertial fixed coordinate frame denoted by F_{I}, this frame is constant and used to describe the overall wheel motions within. The frame origin is located in such a way that the starting points of the wheel are in its positive x and y coordinates. The second frame of reference used is the body frame denoted by F_{B} and is situated at a fixed point with respect to the outer rim 110 of the wheel 100. This frame follows the same convention as F_{I} but moves and rotates with respect to F_{I}. For initial modelling F_{B} only moves in x and y, however motion in z and rotation about x, y and z is expected. The third frame of reference is attached to the centre of the hub 120, and denoted by F_{H}. This frame has six degrees of freedom (DOF) as the centre hub 120 is expected to move and twist with the application of torque and can therefore be described by F_{H}(x, y, z) and its rotation as simplified Euler angles Ω(φ, θ, ψ).

Each actuator or pneumatic piston 130 may have its own coordinate frame, denoted by Fₚi, however, they are not shown in FIG. 6 as it is not directly relevant to the calculations for the mathematical models of the system. A simplifying assumption can instead be made that Equation 1 holds true.

F_{H}(0,0,0)≈Fₚi(0,0,0)+c,∀i, Equation (1)

Where c is a constant offset in x, y and z determined in the design process of the centre hub 120. A point in a set coordinate frame can be transformed to a different coordinate frame using a transformation matrix denoted by T·ⱼⁱT is the notation used to denote a transform from reference frame i to j. Tⱼⁱ is the full rotation matrix for the elemental rotation about Ω(φ, θ, ψ) and is given by

$$\begin{matrix} & Equation ( 2 ) \\ {T}_{j}^{i} ( ϕ , θ , ψ ) = [ \begin{matrix}c ( ϕ ) c ( θ ) & \begin{matrix}c ( ϕ ) s ( ψ ) s ( θ ) - \\ c ( ψ ) s ( ϕ )\end{matrix} & \begin{matrix}s ( ϕ ) s ( ψ ) + \\ c ( ϕ ) c ( ψ ) s ( θ )\end{matrix} \\ c ( θ ) s ( ϕ ) & \begin{matrix}c ( ϕ ) c ( ψ ) + \\ s ( ϕ ) s ( ψ ) s ( θ )\end{matrix} & \begin{matrix}c ( ψ ) s ( ϕ ) s ( θ ) - \\ c ( ϕ ) s ( ψ )\end{matrix} \\ - s ( θ ) & c ( θ ) s ( ψ ) & c ( ψ ) c ( θ )\end{matrix} ] , & \end{matrix}$$

where φ, θ, ψ are the Euler angles corresponding to rotations around the (x, y, z) axes. c( ) and s( ) are shortened notation for cosine ( ) and sine ( ), respectively. Equation 2 is used to model the rotation in the true six DOF of the system, however when the rotation is only present about a single DOF, the translation on a two-dimensional (2D) plane can be incorporated into the equation. The equation can be modified to

$${T}_{j}^{i} ( x , y , ψ ) = [ \begin{matrix}cos ( θ ) & - s in ( θ ) & {t}_{x} \\ sin ( θ ) & cos ( θ ) & {t}_{y} \\ 0 & 0 & 1\end{matrix} ] , \qquad Equation ( 3 )$$

where θ is the rotation about z axis, tₓ and t_{y} are the x and y displacements, of coordinate frame i−1 from i. A simple transformation can also be made from the F_{B} to the F_{I} of an acceleration vector in order to obtain velocity estimates through integration in F_{I}(x, y, z). Let \ddot{v}_{B} be the measured body-frame acceleration vector, the inertial frame acceleration is therefore given by

\ddot{v}_{I}¹=T_{I}^{B}(ϕ,θ,ψ)\ddot{v}_{B}∀\hat{v}_{B}ϵF_{B}, Equation (4)

where \ddot{v}_{I}¹ is the acceleration vector in the inertial frame and the rotation matrix is given by Equation 2.

Using Equation 4, the velocity vector in F_{I} can be calculated by

\dot{v}_{I}¹=∫\hat{v}_{I}¹(t)dt, Equation (5)

and the displacement in the F_{I} frame is given by

v_{I}¹=∫∫\ddot{v}_{I}¹(t)dt. Equation (6)

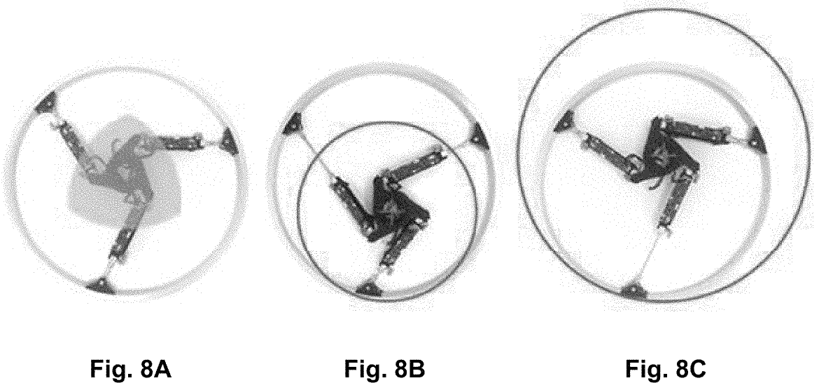

Using Equations 2, 3, 4, 5 and 6 the position and velocity of a point on the wheel can be found with respect to any coordinate frame. The position, velocity and acceleration of the wheel 100 in the F_{B} frame can also be transformed into the position, velocity or acceleration in the F_{I} frame. This is particularly useful when finding spatial coordinates of the wheel in the F_{I} frame. These reference frames are illustrated in FIGS. 6 and 7 for clarity. It will be appreciated that FIGS. 6 and 7 show a system using six actuators, however the embodiment discussed in the following paragraphs discuss a system with three actuators for simplicity.

The conceptual model development arose from predetermined constraints and desired characteristic outcomes. The conceptual model was based on a Reuleaux triangle to inherit the constant height attributes exhibited by the fundamental composition of the geometric shape. Three pneumatic actuators were in turn used to inherit this triangle configuration.

Each pneumatic actuator has four DOF, one translation and three in rotation. The rotation along its translational axis can be restricted physically restricted. Freedom along the remaining two rotational axes has a direct relationship to the overall dynamics of the system as one is caused by torque and the other due to the three-dimensional (3D) nature of the system and is perpendicular to the torque axis.

In a 2D quasi-static model of the system, all three DOF in rotation can be restricted and therefore not modelled. Trigonometry can translate the 2D system into the 3D system and obtain the hub translation. Torque will vary significantly with the speed of rotation, wheel traction, forces applied to the system etc., for this analysis it is assumed constant and as a result the rotational DOF can be ignored. Using these assumptions, it is possible to model the system by defining an inertial, a body and a hub coordinate frames and compute their transforms using the equations presented in previous paragraphs.

### Schematic Model

A schematic model of the system was developed and is shown in FIGS. 5 and 6. This shows the inertial coordinate system (F_{I}) defined with respect to the overall wheel 100, the body coordinate system (F_{B}) with respect to a point on the rim and the origin of the hub coordinate system (F_{H}) fixed to the centre of the wheel. FIG. 7 shows the wheel 100 from top view, Z_{H} denotes a third degree of freedom that is not evident in FIG. 6. The extrapolation from a 2D plane to the 3D system can be performed via trigonometry and the magnitude of the triangle with ∠αᵢ can be found by

Lᵢ=\sqrt{kᵢ²+hᵢ²,} Equation (7)

where hᵢ is a set variable and kᵢ is calculated with the use of matrix transformation. Similarly, the value of Lᵢ is found by performing matrix transforms from measured dimensions of the wheel in the inertial frame. The following transformation equation

Pᵢ^{I}=^{I}T_{H}*(Pᵢ^{H}+P_{centre}^{H}),∀iϵF_{I}, Equation (8)

can be used to obtain the point of each cylinder in the inertial frame. Once these points are found in the inertial frame, the vector magnitude can be used to find the specific distance of Lᵢ using

∥Lᵢ∥={square root over (\vec{lₓ}²+\vec{l_{y}}²)},∀x,y Equation (9)

where \vec{l} is a vector between point Pᵢ^{I} and Fᵢ^{I}.

### Centre Hub Movement Analyses

The centre hub of the wheel is constrained by three points via the pneumatic actuators, and has six DOF as described in previous paragraphs. However, all the rotational DOF are set to zero as they can physical be constrained. Finding the 2D position of the hub can be done via modelling physical limitations of each cylinder into the equations, such as the stroke length. Let Lₛₜᵣₒₖₑ be the maximum stroke length of the cylinder, and Lₒᵥₑᵣₐₗₗ be the overall length of the cylinder when the cylinder is fully contracted. The following holds true for the minimum and maximum length of the cylinder

Lₘᵢₙ=Lₒᵥₑᵣₐₗₗ, Equation (10)

Lₘₐₓ=Lₒᵥₑᵣₐₗₗ+Lₛₜᵣₒₖₑ. Equation (11)

The travel space of the centre hub is limited by a number of physical design characteristics, but most fundamentally by the stroke and orientation of the pistons. In the F_{H} frame, given the Pᵢ points are mounted on the equation of a circle

(x−h)²+(y−k)²=L²ₘₐₓ,∀x,yϵF_{H}, Equation (12)

where h and k are the F_{H} origins, therefore are both zero. The hub's reach in the 2D plane is then characterised by

x²+y²=L² 0≤L≤Lₘₐₓ. Equation (13)

Calculations of the range of movement in the third dimension (Z_{H}) are less trivial as the range is restricted by a number of physical design variables. Therefore, no fixed method is proposed, however the centre hub movement in the Z_{H} axis is directly proportional to the physical design and characteristics of the system.

### Gear Ratio Manipulation

By adjusting the height of the centre hub with respect to the ground, the gear ratio of the wheel can be changed. The physical characteristics of the wheel remain the same while a ‘virtual’ wheel is created with a different gear ratio that maintains a uniform circular motion. The angular speed remains unchanged at any point on the wheel, as for every full rotation of the hub, the outer rim makes a full rotation. However, the linear speed is tangent to the circular path and therefore different at different distances, which allows for the creation of a virtual wheel. For one rotation of the wheel, the distance travelled is found using

d=2πr,Lₘᵢₙ≤r≤Lₘₐₓ, Equation (14)

the velocity of the wheel over the same distance is given by

v=ωr Lₘᵢₙ≤r≤Lₘₐₓ. Equation (15)

As ω remains the same, r is directly proportional to v at a given r on the wheel. Points along a circle can be followed by the centre hub to achieve this and are given by

(x−h)²+(y−k)²=r². Equation (16)

### Overall Design Approach

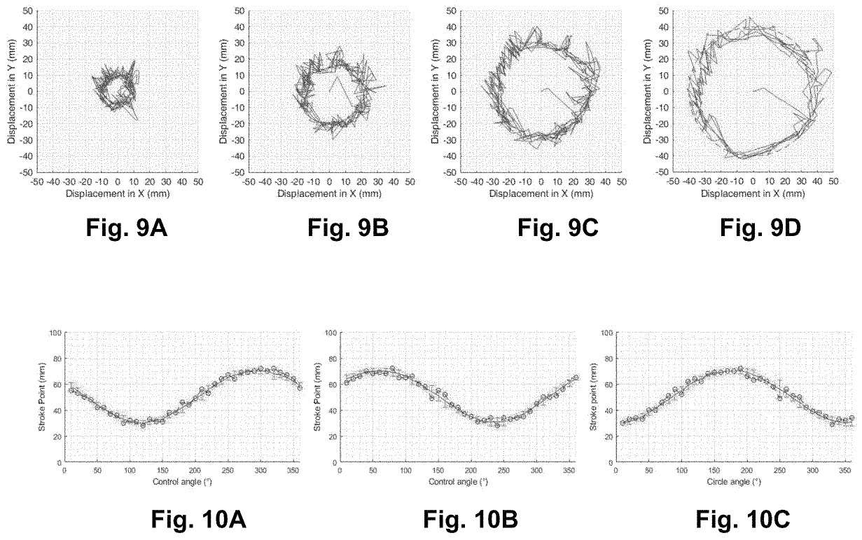

The exterior design of the wheel was a conventional round wheel, although as mentioned other shapes of wheel rim could be used. In this example, the centre hub of the wheel and the spokes linking the two components were modified. The centre hub was designed with strength and lightweight in mind, as it is foreseen to undergo stresses in multiple directions and contribute to the overall weight of the wheel. The hub was also designed to maximise the freedom of motion once attached to the spokes, as this has a direct impact on the motion and configurability of the wheel. A configuration of three actuators was used to allow accurate positional control on a 2D plane. FIG. 8A shows the overall wheel design where the actuator is mounted. The actuator mounting points are offset from the centre of the hub to allow the wheel diameter to remain smaller, while allowing the same stroke length as direct mounting. FIG. 8B shows the virtual wheel with a smaller radius and FIG. 8C a virtual wheel radius greater than the physical wheel.

### Smart Pneumatic Actuator (SPA)

A movement actuator is provided, which is based on a standard pneumatic linear modified to include an array of Hall effect sensors, that is mounted to the external casing of the pneumatic cylinder. The Hall effect sensors can read a magnet mounted to the end of the piston and produce an accurate positional measurement, after some on board processing is performed by the actuator controller.

Additionally, accurate positional control is achieved using a simple bang-bang controller controlling a 5/3 close centre solenoid valve, which controls the airflow to each chamber of the cylinder and in turn the position of the piston.

### Actuator Control

A control protocol is used to address each SPA, whose physical address is set using slide switches on a PCB. This works by daisy-chaining a number of the systems onto a single line and as a result provides an effective and straightforward means of communications. The commands for each of the SPAs are calculated by an algorithm running on a computer on the same serial line, which ensures that the computer is utilised for performing any computational intensive tasks to decrease any latency this may introduce into the control loop.

Power and compressed air are also provided to the system from an external source. One air line, two power and two signal lines are the systems only tether to the external world, totalling five individual connections. External pressure regulators and flow controllers were utilised to help ensure a stable supply of air.

### Validation

Experiments were performed to validate that pneumatic cylinders exhibit sufficient control for the proposed use. A number of experiments were performed to test cylinders with force loading while coupled to the configurable wheel.

### Ground Truth

Individual Cylinder: The ground truth for evaluating the response of each of the cylinder's controllers was devised by utilising the Hall affect sensors on board. These sensors are calibrated using a string transducer to ensure the mathematical model for their response is correct. Once validated, a second calibration was performed to calibrate the individual sensor each time the controller PCB is powered on. The sampling rate is controlled by the controller input rate, as at each time step the position feedback is used by the controller to make adjustments and evaluate its performance. The resolution of this measurement was 0.28 mm over the 100 mm stroke of the cylinder.

Overall System: A second approach was undertaken when recording the position of the centre hub with respect to the outside rim to eliminate any error present. This was done using visual tracking, using a camera mounted perpendicular to the centre hub. The camera then tracked a red dot mounted on the hub and after calibration provided the x and y positions at about 12 Hz. This data was not synchronised with the positional inputs and is therefore used primarily to track the positions between serial inputs. This data also gives an insight into the oscillation that is present in the cylinders positions as they converge towards steady state. The underlying settling time can be seen and determined from this method as it is significantly faster than the individual cylinder sampling through serial, under the current control conditions.

### Kinetic Model Validation

The kinematic models developed were validated in simulation and subsequently on the physical system. The reverse kinematics approach is used to determine the position of each piston with an input of x and y in the F_{H} coordinate fame. This provides the positions for each of the pistons and was tested extensively as it is a fundamental property of a reliable and accurate control system. This model of the system is reliable and works well.

### System Results

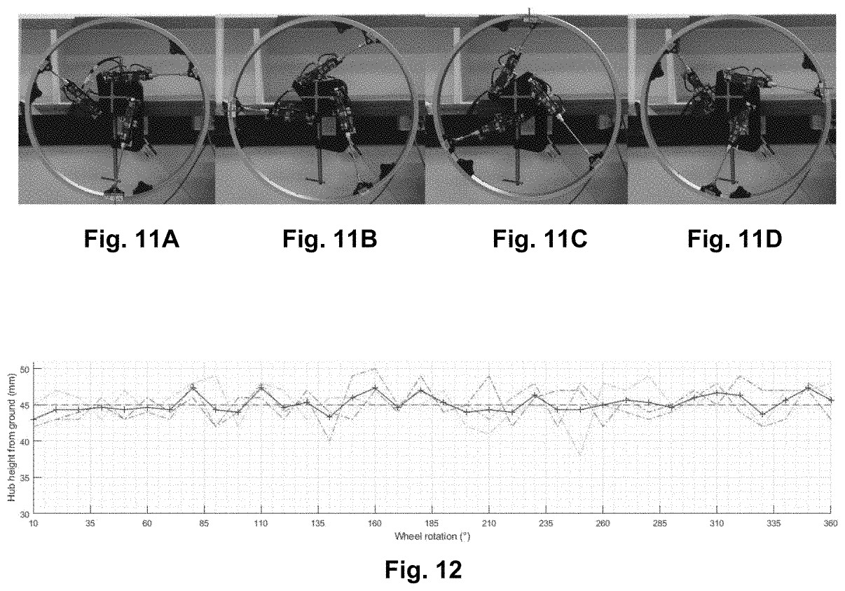

General Control: FIGS. 9A to 9D show data from four individual experiments. These experiments were performed to test the validity of the assumption that a pneumatic actuator exhibits sufficient control resolution to allow controlled manipulation of the centre hub. To validate this, the controller was tasked with following a path of four varying circle radii calculated using Equation 16.

It is seen in FIGS. 9A to 9D that the movement follows a circular path, with some oscillations seen along the circumference. This oscillation is caused by the control algorithm overshooting and over-correcting the piston positions. Fundamentally, the physical switching time limitations of the solenoid valve contribute to this as the piston is only able to adjust its position in set resolution which is directly proportional to air pressure, air flow and the forces felt on the piston at that instant. The addition of an air pressure regulator and a flow controller greatly reduced this oscillation and the final results are presented in the figure.

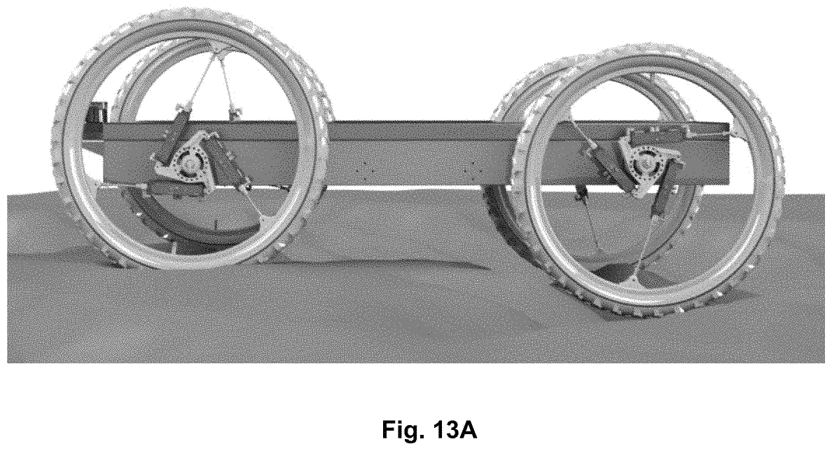

Individual Cylinder Control: FIGS. 10A to 10C shows the same fundamental movement of the hub as seen in FIGS. 9A to 9D, however this data is split up into positions of the individual pistons. This allows for insight into how each of the pistons responds to its control input and how this affects the overall hub position. It can be seen that the data shows promising results with some oscillations also present on the piston position level. However, if oscillation is created by one piston, the other two opposing positions generally dampen it to provide a smoother overall motion of the centre hub.

The standard deviation of the position varies between the pistons, but is on average 8.7 mm. As the system is mechanically coupled, this deviation from the control input could result in extra stress on certain components of the system. However, due to the underlying compressibility of air, this does not raise concern as the system exhibits compliance via the pneumatic cylinders. The control system would benefit from further tuning to eliminate this oscillation and yield a more stable positional control. Overall, these figures show that the circular motion of the centre hub is achievable with pneumatic actuators with minor control discrepancies.

### Gear Ratio and Ride Height Manipulation

The system can also be configured to allow active adjusted of the ride height of a wheel. In doing so the gear ratio is also changed and the instantaneous velocity around the rim altered, according to Equations 14 and 15. FIGS. 9A to 9D shows the motion of the hub with the rim fixed and serves as a preliminary proof of concept.

Further, an experiment was conducted which involved fixing the centre hub vertically onto a free-turning axle. This allowed experiments to be conducted under the same orientation as the final system is envisioned to function, under the load of gravity through its Y_{I} axis. Under this configuration no frictional or normal forces were exhibited on the wheel, as a result stiction and gravity were the major forces acting on the wheel.

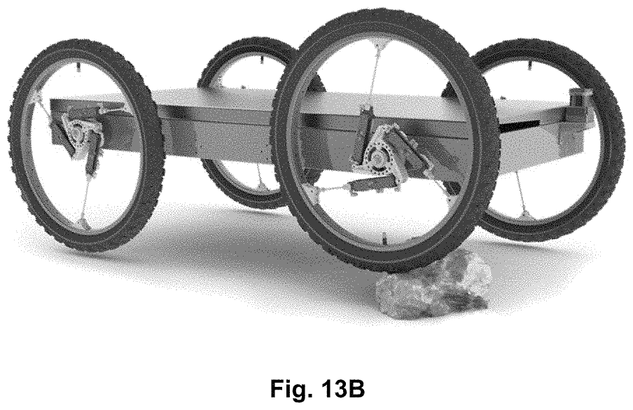

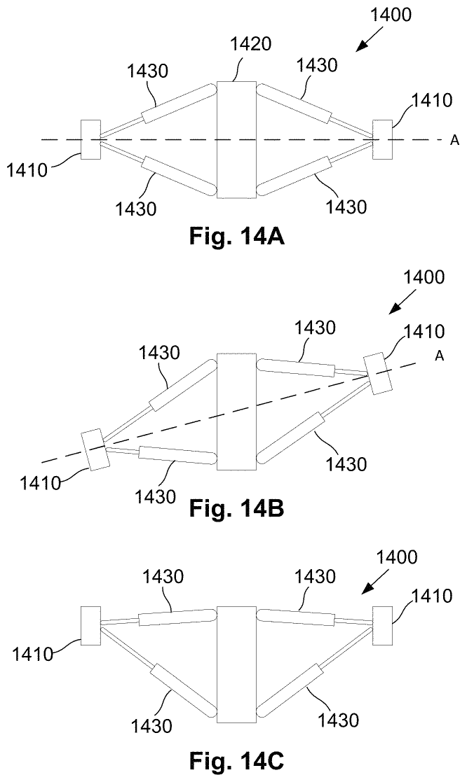

FIGS. 11A to 11D show four snapshots of a full rotation performed by the wheel, with the radius manipulated. The default radius of this prototype wheel is 237 mm, with the ability for adjustments of ±50 mm. This allows the wheel to change its characteristics by about 42%. The results in FIG. 12 show and adjustment of +30 mm throughout the wheels full rotation. The initial rotation of 50° and the final of 30° shows the wheel undershooting the desired hub position.

These anomalies in the data are likely present due to the nature of the under-constrained system. The rim exhibited minor oscillation in its axial (Z) plane. This was caused due to the rim being constrained by only three points (P₁, P₂ and P₃ in FIG. 6) on the same plane, as a result the system was under-constrained. This can be corrected for by adding extra pistons to the system or constraining it using other mechanical means.

Accordingly, the above described arrangement provides a configurable wheel that exhibits desired properties of varied radius wheels. Positional manipulation of the centre hub enables the system to provide desired characteristics of ‘virtual’ wheels in a physical system. The centre hub is manipulated via the use of linear actuators, such as pneumatic actuators, mounted to and constricted by the outer rim of the wheel, which allows for fast and accurate control to enable the vehicle ride height and wheel gear ratios to be adjusted continuously and be maintained during the wheels' full rotation.

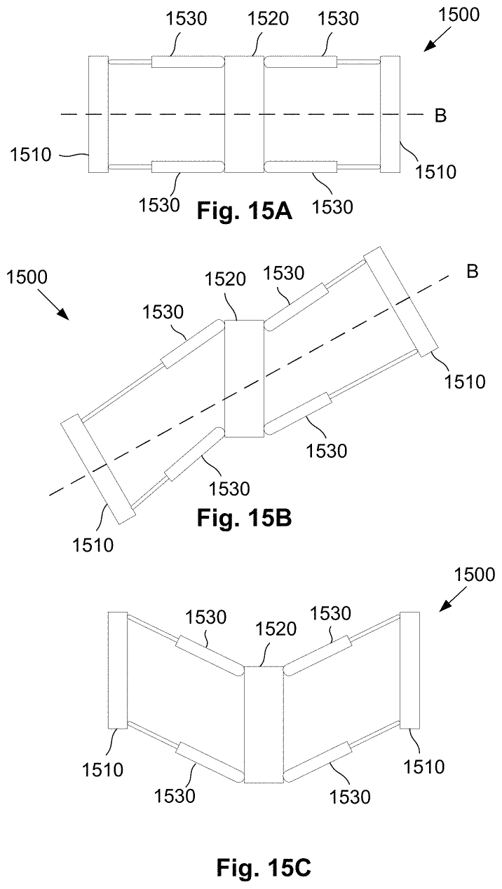

The above described arrangement has a number of potential applications, such as off-road robotics, as shown in FIGS. 13A and 13B.

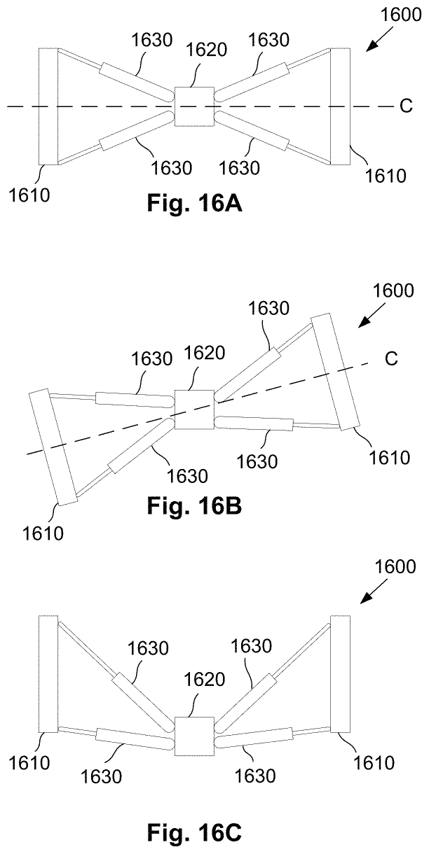

A further example of a wheel will now be described with reference to FIGS. 14A to 14C.

In this example, the wheel 1400 includes a substantially radially rigid rim 1410. The rim 1410 can be similar to the rim 100 as described. The wheel 1400 further includes a hub 1420 provided for mounting the wheel 1400 to an axle (not shown). The hub 1420 can be fixed to the axle, allowing the wheel to be driven by the axle, or could be rotatably mounted to the axle, allowing the wheel to rotate freely, or be driven by another drive mechanism, such as a sprocket and chain arrangement.

The hub 1420 acts to supports a plurality of actuators 1430, which couple the rim 1410 and the hub 1420. The nature of the actuators will depend on the preferred implementation and could include linear actuators, such as electric, pneumatic or hydraulic actuators, non-linear actuators, or the like.

At least some of the actuators 1430 are configured to act outside a plane A of the rim, which extends through a centre of the rim. In the current example, the actuators 1430 are attached to the hub 1420, so that a hub end of the actuators are spaced in an axial direction, and with a rim end of the actuators being substantially coincident at the rim 1410, so that the actuators 1430 are angled relative to the plane A, allowing lateral forces to be applied to the rim. However, as will be apparent from the following description, a range of different arrangements can be used and the current arrangement is not intended to be limiting.

In this example four actuators are shown in plan view, but it will be appreciated that this is simply to demonstrate the principle that allows the application of lateral forces to be applied to the rim. It will be appreciated that in practice different arrangements and number of actuators could be used, with six actuators being provided in a preferred example described in more detail below. However, a smaller number of actuators could be used, such as one or two actuators, with these being used in conjunction with other supporting elements, such as passive pneumatic pistons, or other similar arrangements, to allow the rim to be supported whilst the hub undergoes movement. In this instance, the range of movement may be limited compared to scenarios in which three actuators are used. Additionally, it is also possible to use larger numbers of actuators, for example to provide for increased robustness, or redundancy, or to increase the weight bearing capability of the wheel.

In use, controlling the actuators 1430, and in particular selectively controlling the length of each actuator 1430, allows the hub 1420 to be moved relative to the wheel rim 1410 thereby allowing a hub position to be controlled, which in turn can be used for a number of purposes. In FIGS. 14A and 14B, the actuators 1430 are acting outside of the plane A, this can be used to move some or all of the rim laterally, which in turn can be used to offset the rim and hub and/or to rotate the rim relative to the hub and about an axis perpendicular to the axle, thereby effectively steering the wheel. This also allows the wheel to move with six DOF and six degrees of actuation (DOA).

In FIGS. 14A and 14C, the actuators 1430 are also acting outside of the plane, and the length of each actuator 1430 is controlled, so that the hub position is move relative to the rim 1410, thereby effectively tilting or laterally offsetting the wheel.

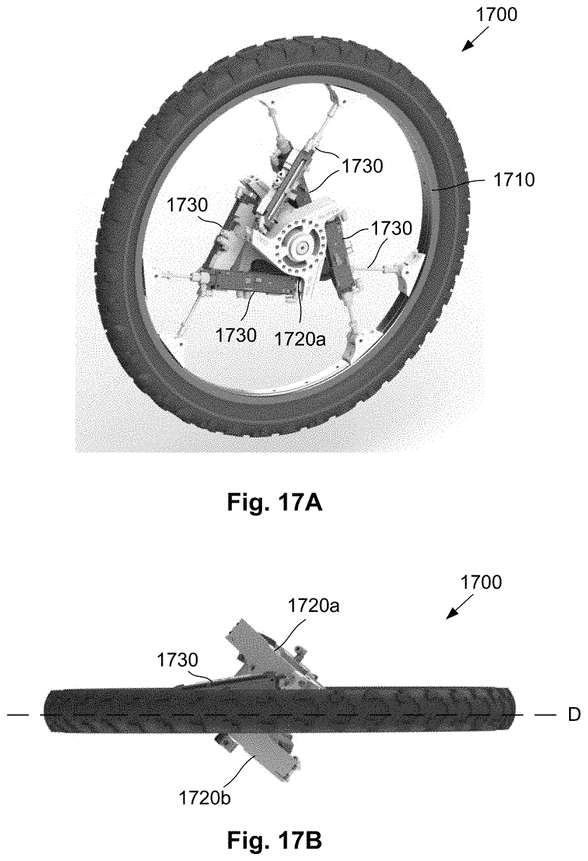

A further example of a wheel will now be described with reference to FIGS. 15A to 15C.

In this example, the wheel 1500 includes a substantially radially rigid rim 1510 and a hub 1520 provided for the rim 1510 for mounting the wheel 1500 to an axle (not shown). The hub 1520 acts to support at least one actuator 1530, which couples the rim 1510 and the hub 1520, and at least some of the actuators 1530 act outside a plane B of the rim.

In use, controlling the actuators 1530, and in particular selectively controlling the length of each actuator 1530, allows the hub 1520 to be moved relative to the wheel rim 1510 thereby allowing a hub position to be controlled, which in turn can be used for a number of purposes.

In this example, the rim 1510 extends in an axial direction, and the actuators 1530 are attached to the hub 1520 and rim 1510, so that hub and rim ends of the actuators are spaced in the axial direction. Accordingly, this allows the actuators 1530 to acting outside of the plane B, this can be used to move some or all of the rim laterally, which in turn can be used to offset the rim and hub and/or to rotate relative to the hub, for example to allow the wheel to be steered as shown in FIG. 15B, or to allow the wheel to be tilted or laterally offset as shown in FIG. 15C.

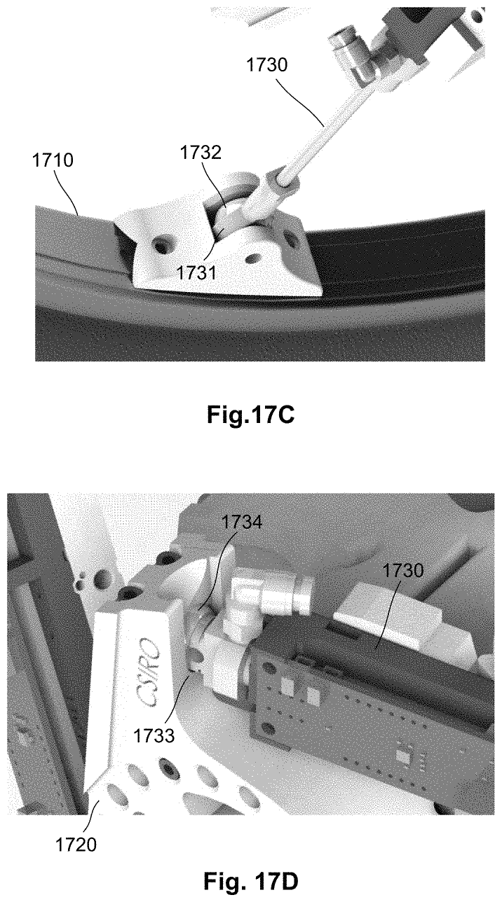

A further example of a wheel will now be described with reference to FIGS. 16A to 16C.

In this example, the wheel 1600 includes a substantially radially rigid rim 1610 and a hub 1620 provided for the rim 1610 for mounting the wheel 1600 to an axle (not shown). The hub 1620 acts to support at least one actuator 1630, which couples the rim 1610 and the hub 1620, and at least some of the actuators 1630 act outside a plane C of the rim.

In use, controlling the actuators 1630, and in particular selectively controlling the length of each actuator 1630, allows the hub 1620 to be moved relative to the wheel rim 1610 thereby allowing a hub position to be controlled, which in turn can be used for a number of purposes.

In this example, the rim 1610 extends in an axial direction, and the actuators 1630 are attached to the hub 1620 and rim 1610, so that rim ends of the actuators are spaced in the axial direction, whilst hub ends are substantially coincident. Accordingly, this allows the actuators 1630 to acting outside of the plane C, this can be used to move some or all of the rim laterally, which in turn can be used to offset the rim and hub and/or to rotate relative to the hub, thereby allowing the wheel to be steered as shown in FIG. 16B, or to allow the wheel to be tilted or laterally offset as shown in FIG. 16C.

Accordingly, the movements of the hub relative to the rim can be used to cause movement of the vehicle. For example, steering the wheel allows the vehicle to change direction when travelling, and tilting the wheel allows the vehicle to move laterally, which can be useful to avoid obstacles.

Accordingly, it will be appreciated that the above described arrangement can provide a wheel with vastly increased functionality. This is particularly useful in a wide range of applications, such as on autonomous vehicles or rovers, as this enables the vehicle to cope with a far wider range of terrain than would otherwise be the case, whilst maintaining a simple lightweight configuration, and/or providing improved efficiency.

A number of further features will now be described.

In this regard, it will be appreciated that the features previously described above, such as the types of actuators and their configuration, can be implemented in the current embodiments, and this will not therefore be described in any detail.

In one example, the one or more actuators are pivotally mounted to the hub and the rim using ball and socket joints. This allows the actuators to move relatively to the hub and/or the rim with at least three DOF, thereby lifting, steering or tilting the wheel.

In one example, the wheel includes two hubs connected to the rim relatively parallel to one another. This allows each hub to rotate independently, thereby facilitating in distributing torsional force on each hub when steering or tilting the wheel. Additionally, this allows the wheel to have more DOF and DOA, which is particularly useful for hubs that operate in two-dimensions.

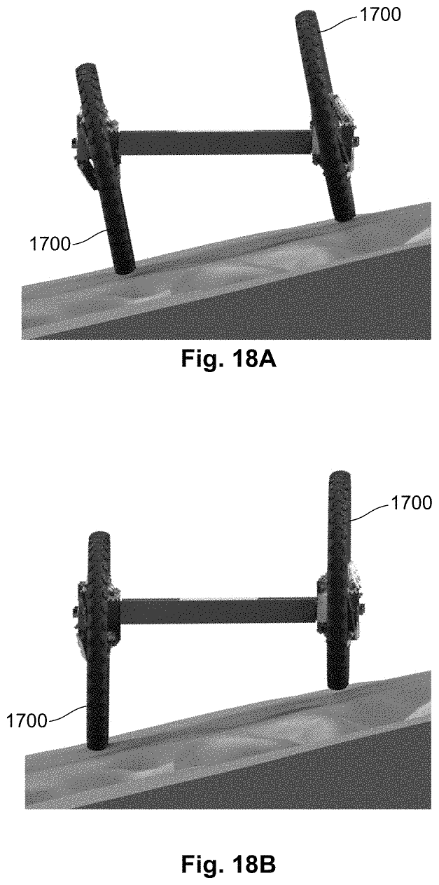

In one example, each hub may be connected to three actuators. This provides better control of the hub position without increasing the weight and complexity of the wheel. An example of this will now be described in more detail with reference to FIGS. 17A to 17C.

In this example, the wheel 1700 includes a substantially radially rigid rim 1710. The wheel 1700 further includes two hubs 1720a, 1720b provided for the rim 1710 for mounting the wheel 1700 to an axle (not shown). Each hub 1720 acts to support three actuator 1730, which couple the rim 1710 and the hub 1720, and which act outside a plane D of the rim 1710.

Each actuator 1730 is pivotally mounted to the hub and the rim. In this example, the actuator 1730 is mounted to the rim 1710 and hub via respective ball and socket joints. In this example, a shaft 1733 the actuator 1730 terminates in a ring socket 1731, which engages a ball 1732, retained within a bracket 1734 mounted on the rim 1710. In this example, the actuator 1730 is mounted to the hub 1720 with another ball and socket joint, wherein the hub 1720 includes a socket 1733 in contact with a ball 1734 mounted on a hub end of the actuator 1730. It will be appreciated that the configurations of ball and socket joints can be modified to provide different ranges of motions and DOF of the actuator 1730. It will also be appreciated that other suitable joints could be used.

The above described arrangement allows a range of different wheel motions to be achieved, including rotating the wheel rim relative about the hub, about an axis perpendicular to the axle, thereby steering and/or tilting the wheel.

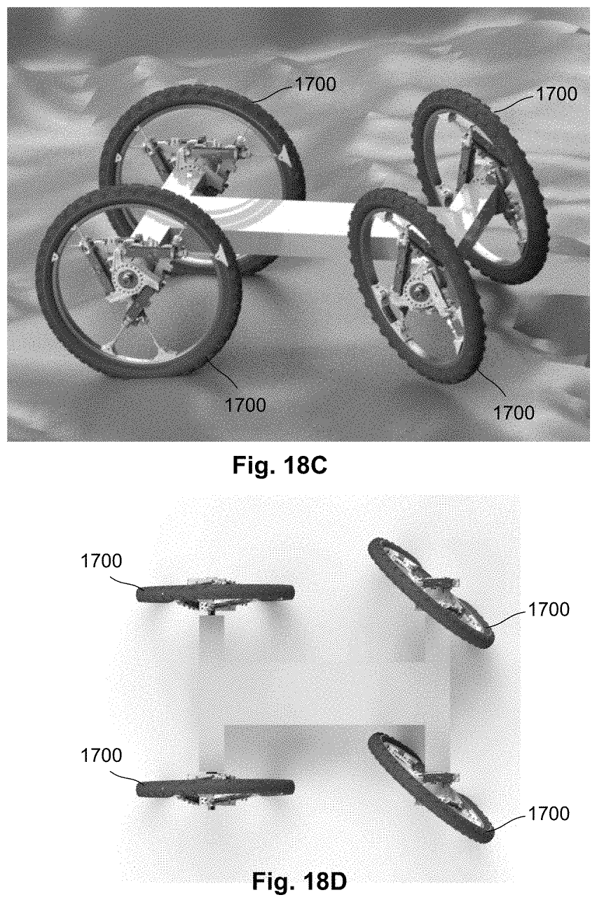

As shown FIGS. 18A and 18B, the tilting the wheels 1700 relative to the axle can be used in conjunction with differential ride heights, so as to maintain a vehicle chassis 1800 in a substantially horizontal orientation so that the vehicle remains levelled while traveling through uneven ground. Furthermore, this can be performed so that the wheels remain perpendicular to the ground, as shown in FIG. 18A, or remain vertical as shown in FIG. 18B, which can be advantageous depending on the nature of the terrain being navigated. Particularly. It is advantageous to shift the vehicle Centre of Gravity (COG) as shown in FIG. 18B when travelling on a hill. This increases the vehicle's slope traversability which helps in minimising the possibility of a vehicle rollover on steep terrain. It will also be appreciated that other wheel orientations could be provided, and that these are for the purpose of illustration only.

Additionally, the wheels can also be controlled to steer the vehicle as shown in FIGS. 18C and 18D.

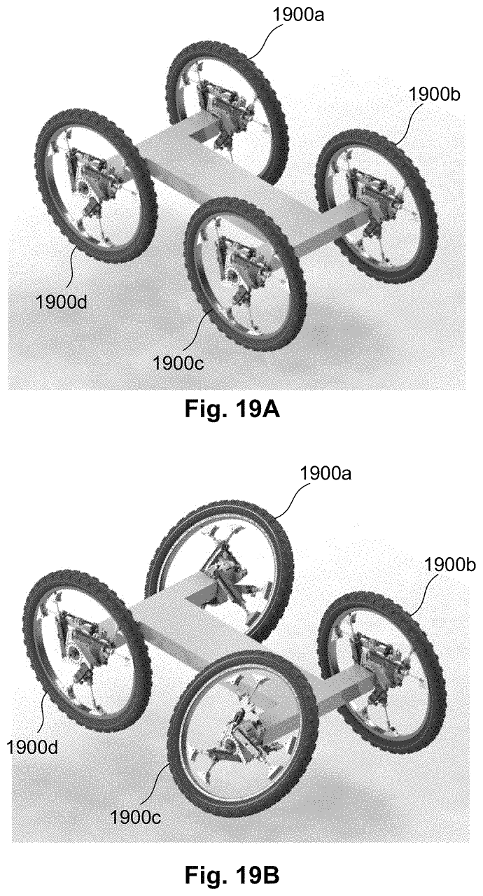

A further example of a wheel in use will now be described with reference to FIGS. 19A to 19D.

In this example, the vehicle is mounted with four wheels 1900a, 1900b, 1900c, and 1900d. FIG. 19A shows the vehicle in an initial position. FIG. 19B shows two diagonally opposite wheels 1900a, 1900c tilted so that the wheels are off the ground. Next, the other two wheels 1900b and 1900d are tilted in an opposite direction to the previous tilt direction as show in FIG. 19C. In this step, the vehicle is the moved laterally in the direction of arrow L by virtue of the wheels 1900b, 1990d tilting while remaining in contact with the ground, until the wheels 1900a, 1900c contact the ground. FIG. 19D shows the wheels 1900a, 1900c tilting back into a vertical orientation, which lifts the wheels 1900b, 1900d, which remain tilted, and further moves the vehicle in the direction of arrow L. By this process, the vehicle travels laterally in direction L, which can be useful in obstacle avoidance. Another benefit would be to inherit properties of legs by being able to “step” out of a hole or to pull the vehicle out of a bog.

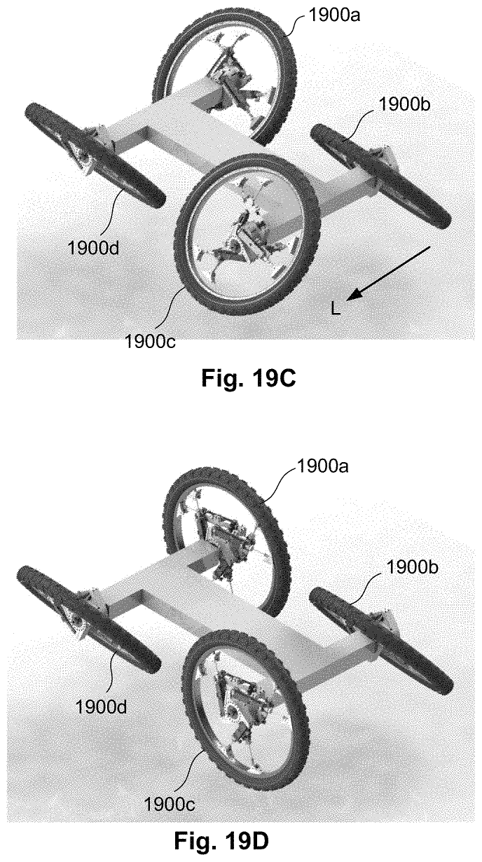

It will be appreciated that lateral movement can be achieved using other sequences of motion. For example, as shown in FIG. 20, the vehicle may move by tilting all wheels first, and then lifting some of the wheels off the ground. The lifted wheels are then tilted and lowered to contact the ground. While holding these wheels still, the rest of the wheels are lifted first, and then moved to a vertical orientation to contact the ground at new forward locations. Finally, all wheels are moved back to a vertical orientation.

In this example, the wheel with two hubs operates in a similar manner as the steps described in previous paragraphs with reference to FIG. 5. Specifically, a control system of a vehicle determines an action to be performed, such as to steering or laterally moving the vehicle, and calculates a wheel hub position in a wheel frame of reference. The control system determines a current wheel orientation and movement to transform the wheel hub into a rim frame of reference to thereby calculate a hub target position. The target hub position is then used to calculate actuator target lengths, which are transferred to the respective actuator controllers, allowing the control valves to be operated so that the actuator lengths are adjusted as required.

Accordingly, the mathematical modelling of the system proposed in this example is also described in previous paragraphs with reference to FIGS. 6 and 7. It will be appreciated that FIGS. 6 and 7 show a system using two hubs and six actuators. Three major frames of reference are used. These reference frames are illustrated in FIGS. 6 and 7 for clarity. The first frame is the inertial fixed coordinate frame denoted by F_{I}, this frame is constant and used to describe the overall wheel motions within. The frame origin is located in such a way that the starting points of the wheel are in its positive x and y coordinates. The second frame of reference used is the body frame denoted by F_{B} and is situated at a fixed point with respect to the outer rim of the wheel. This frame follows the same convention as F_{I} but moves and rotates with respect to F_{I}. For initial modelling F_{B} only moves in x and y, however motion in z and rotation about x, y and z is expected. The third frame of reference is attached to the centre of the hub, and denoted by F_{H}. This frame has six degrees of freedom (DOF) as the centre hub is expected to move and twist with the application of torque and can therefore be described by F_{H}(x, y, z) and its rotation as simplified Euler angles Ω(φ, θ, ψ).

Each actuator or pneumatic piston may have its own coordinate frame and be considered in the mathematical model. Alternatively, a simplifying assumption can instead be made that Equation 1 holds true. Using Equations 2, 3, 4, 5 and 6 the position and velocity of a point on the wheel can be found with respect to any coordinate frame. The position, velocity and acceleration of the wheel in the F_{B} frame can also be transformed into the position, velocity or acceleration in the F_{I} frame. This is particularly useful when finding spatial coordinates of the wheel in the F_{I} frame.

Another specific example of the wheel is described below in detail. It will be appreciated that the described configuration is for exemplary purpose, and numerous other configurations may be used.

There are systems comprising a rigid-wheel with a form of suspension system, however, they have limited vehicle body pose control or active wheel adjustment properties. An example of a limitation of these systems is the NASA Spirit Mars rover that became stuck in a ‘sand trap’ in late 2009, as the only wheel pose control it possesses is angular velocity control of its wheels.

An example is a spatially variable origami wheel to offer variable torque in a small, lightweight and passive system. This offers continuous torque adjustment by deforming the wheels and reducing their diameter as a torque load is applied. Other examples propose a shape-changing wheel that generates locomotion by changing its external shape to eliminate the need for drive trains and motors, greatly reducing the overall complexity and size. Similarly, a system using deformable wheels and hybrid actuators with smart structures and composite flexure linkages has been proposed. It deforms its wheels to generate locomotion and can in turn navigate small spaces and openings by spatially adjusting its wheel footprints. Another approach proposes moving via a series of discrete steps by using polygons (and polyhedrons) in which the accelerations of edge lengths are controlled to cause tipping motions over desired vertices. Further from the wheeled system, snake-like locomotion for exploration and dynamic locomotion via shape shifting walking, crawling and rolling robot are proposed for applications such as urban reconnaissance and surveillance.

The above approaches tackle locomotion differently, however Cost of Transport (COT) is lowest with traditional wheeled systems, although lacking configurability like others, to allow movement through dynamically changing terrains.

This example, the wheel can act as a passive wheel to inherit the low COT and structural integrity of traditional system, or when desired, exhibit dynamic centre hub positional control to allow vehicle pose control and provide an alternative locomotion system using gravity to generate a moment about its axles.

The primary motivation for this example extends into significantly increasing chassis pose control by changing the effective radius of wheels, compared to traditional wheeled systems. This allows for the manipulation of the platform centre of gravity (COG), which can be used for generating locomotion using gravity and active wheel positional control.

Secondary, the COG manipulation allows for increased slope traversability of the platform as the COG can be lowered and shifted uphill. Dependent of the slope angle and shift parameters, doing so also generates a moment about the wheel axle and helps drive the platform uphill. This method of locomotion can be used to add extra torque to the motors, or as a redundancy locomotion system provided gearbox drive disengagement is possible.

Use cases for this system are numerous, with the major envisioned uses being terrestrial and extra-terrestrial rovers and platforms designed for hill climbing. Uses that require robot body pose control such as sensitive payload transport are also perceived to benefit from this research.

### Component and Overall System Design

### Wheel Overview

In this example, the wheel is a three degrees of actuation (DOA) system. The wheel includes a rigid rim and centre hub, mechanically coupled with three pneumatic cylinders. The coupling mounts are designed to mechanically restrict the motion of the hub within a plane, resulting DOA are in x, y and θ rotational about z axis. This allows the wheel to be locked into a passive state when desired and act as a traditional wheel, maintaining its low cost of transport.

The pneumatic cylinders coupling the rim and hub may be actuated by controlling the airflow via a solenoid valve, controlled by an on-board microcontroller that receives high level commands from an external computer. Inverse kinematic control of the centre hub with respect to a point on the rim is used, to allow positional control throughout the wheels full rotation. Each wheel is supplied with pressurised air, power and a communications line. The three tethers to the external world are daisy chained together to minimise the number of connections to the system.

### Chassis Overview

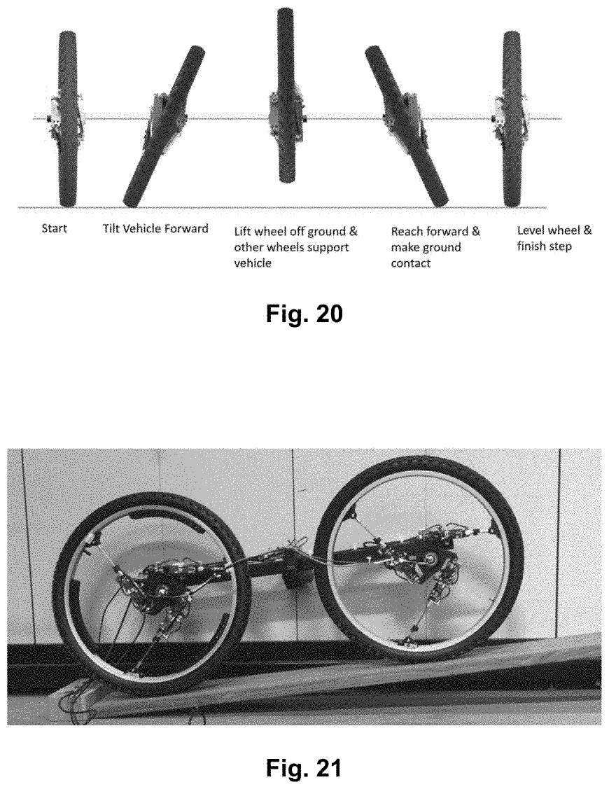

As shown in FIG. 21, the chassis includes a rigid cross-member providing in-line mounting points for two wheel axles. The wheel axles are mounted onto the chassis in parallel one after another, as a bicycle, spaced a sufficient distance apart to ensure the wheels can move without colliding when the effective radius is manipulated. A caster wheel was added to the cross-member in order to support and balance the system on a smooth surface such as a wall. The two active wheels support all the weight and control the ride height and weight distribution, while the caster wheel rests against a wall, maintaining the chassis upright.

### Data Collection

1) Wheel Rotation: In this example, the rotation of each wheel was recorded using a quadrature rotary encoder running at 100 Hz. The encoder resolution is 600 increments per rotation, and the output is rectangular orthogonal digital pulse.

2) Chassis Height: Each wheel mounting point has a ground time-of-flight laser sensor utilised as a ride height sensor. This sensor measures the instantaneous distance between the centre of the wheel and its contact patch, and is time-stamped to allow data analyses in conjunction with the rotation of the wheel sensor.

3) Collection and Analyses: The data are collected using an Arduino and streamed via serial to a computer. The raw data are then evaluated and plotted using MATLAB.

4) Environment: The above steps are performed in a controlled environment with a polished concrete floor and the sloped angles created using a plank of wood to maintain sufficient traction with the wheel and eliminate slip. A consistent supply of pressurised air is provided from an external industrial air compressor and reservoir.

### Definitions and Assumptions

### Frames of Reference

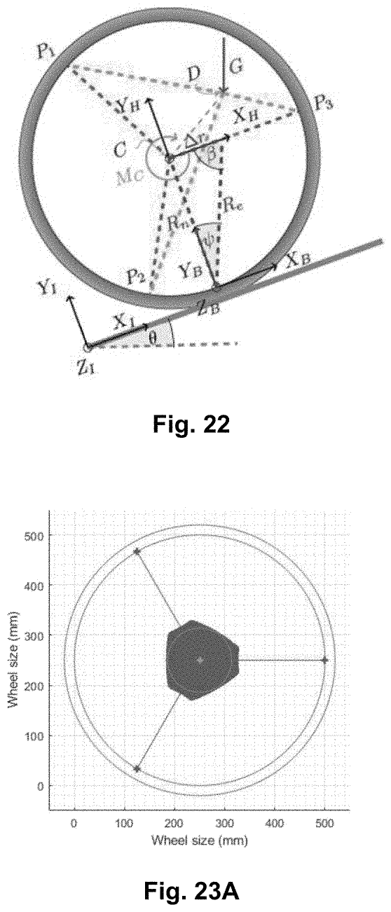

With reference to FIG. 22, this wheel uses a number of frames of reference in order to simplify the calculations. Main frames used are the centre hub F_{H} frame which is fixed to the nominal centre of the wheel but does not co-rotate with the wheel. A secondary frame F_{E} is fixed to the hub and moves with respect to x and y to F_{H} as the effective wheel radius is changed. Frame F_{B} is the wheel body frame that is fixed to a point on the rim, with its x axis pointing through the origin of F_{H} and is used to measure the effective wheel radius. The overall wheels and chassis move in an inertial frame F_{I} and the frame F_{C} is fixed to the COG of the chassis under nominal conditions. F_{C} is used to describe the wheel positions with respect to the chassis.

### Ground Contact and According Assumptions

1) Rolling Assumptions: A pure rolling assumption is made in this example with the wheel exhibiting no slip with its contact surface. A rubber tyre is used with an off-road tread pattern to maximise traction and prevent energy loss through slip. This resulted in

\vec{a}=rα, Equation (17)

holding true throughout the calculations and experiments.

2) Contact Patch: The contact patch is characterised by the contact area each wheel makes with the ground. This may be only at a single point per wheel. Calculated by dividing the single wheel load L_{ω} by the tire inflation pressure IP as follows

$$CP = \frac{{L}_{ω}}{IP} . \qquad Equation ( 18 )$$

The centre of the single point in contact with the ground has a velocity of 0ₘₛ⁻¹ as it does not move relative to the ground while in contact, to satisfy Equation 17.

3) Nominal Ground Pressure: The wheel contact pressure is a ratio between the weight and contact patch of the system, used to determine the system suitability for specific environments and can be found by

$$NGP = \frac{{L}_{ω}}{{RW}_{ω}} . \qquad Equation ( 19 )$$

For this example, it is important as it directly contributes to the contact patch calculation. This method may neglect the impact of tire deflection under load and during movement, tire air pressure and independence on specific ground characteristics.

4) Coefficients of Friction: The coefficient of static friction for a soft rubber tire on dry wood was equal to the tangent of the angle at which the wheel began to slide, and the dynamic equal to the angle of which the wheel maintained a consistent slide. The angles were recorded and calculated using

μ=tan(Ø), Equation (20)

which yielded μₛ=0.95 and μₖ=0.8. These values were used in the calculations as it represents the physical testing environment.

### Theoretical Calculations and Validations

### Platform Stability on a Slope

When the platform is at rest on an incline θ, the front R_{F} and rear R_{R} axle loading varies based on θ and chassis design. If the platform with weight M has a COG with vertical distance h from the ground, x_{f} is the offset between the COG and front wheel and W_{B} is the wheelbase, the wheel loading can be found using

$$\begin{matrix}{R}_{R} = \frac{M}{{W}_{B}} ( {W}_{B} - {x}_{f} cos ( θ ) - h sin ( θ ) ) , & Equation ( 21 ) \\ {R}_{R} = \frac{M}{{W}_{B}} ( {x}_{f} cos ( θ ) + h sin ( θ ) ) . & Equation ( 22 )\end{matrix}$$

As the angle θ increases one of two situation can occur; the platform can stay in its statically stable state, or become unstable and overturn. This limiting angle θ_{L} is found by

$${θ}_{L} = {tan}^{- 1} ( \frac{{W}_{b} - {x}_{f}}{h} ) . \qquad Equation ( 23 )$$

### Centre of Gravity

1) Wheel: The centre of gravity (COG) on the x-y plane of each wheel is modelled to be directly proportional to its normal radius. Under nominal circumstances the wheel radius is equal in x and y, as a result its COG is the geometric centre of the wheel. COG in z direction is modelled as proportional to the wheel thickness W_{T}. For all points in hub workspace H_{W} calculated by Equation 45, in reference frame F_{H}, where Rₓ=R_{y}=Rₙ the COG is simply

COGₓ=Rₓ,RₓϵH_{W}, Equation (24)

COG_{y}=R_{y},R_{y}ϵH_{W}, Equation (25)

COG_{z}=W_{T}/2. Equation (26)

Upon actuation, the wheel radius changes unevenly from the centre point Rₓ≠R_{y}, the centre of gravity is then given by

COGₓ=Δr,COGₓϵH_{W}, Equation (27)

COG_{y}=cos(ψ)−Rₙ,COG_{y}ϵH_{W}, Equation (28)

COG_{z}=W_{T}/2. Equation (29)

2) Chassis: Likewise, COG of the chassis is assumed to be in its geometric centre due to symmetry. However, as the effective radius of the wheels changes, it can be found using

COGₓ=−(COGₓ(Wheel₁)+COGₓ(Wheel₂)), Equation (30)

COG_{y}=−(COG_{y}(Wheel₁)+COG_{y}(Wheel₂)), Equation (31)

COG_{z}=−(COG_{z}(Wheel)+(W_{C}/2)). Equation (32)

### Mass Moment of Inertia

The mass moment of inertia (I) of an angular cylinder about its central axis standard formula

$${I}_{N} = \frac{M}{2} ( {R}_{1}^{2} + {R}_{2}^{2} ) , \qquad Equation ( 33 )$$

yields the moment of inertia of this wheel in its normal state. Actively manipulating the wheel radius to shift mass therefore changes the moment of inertia. The parallel axis theorem can be used to determine the new value and states that I=I_{cm}+md²; where I_{cm} is the body moment of inertia with respect to an axis, I is the new moment of inertia offset by distance d from I_{cm} axis. The new I_{E} is then given by

$${I}_{E} = \frac{M}{2} ( {R}_{1}^{2} + {R}_{2}^{2} ) + m Δ {r}^{2} . \qquad Equation ( 34 )$$

### Angular Acceleration

The angular acceleration of the wheel defines the overall wheel acceleration. As the acceleration is proportional to the mass moment of inertia (Equations 33 and 34), an equation is derived for each configuration using the torque equation

τₙₑₜ=Iα. Equation (35)

Substituting values common to both wheels states yields

mg cos(θ)r=Iᵢα,∀i. Equation (36)

Rearranging for α, and substituting Equation 33 and 34 respectively gives the final accelerations of the wheel states

$$\begin{matrix}{α}_{nominal} = \frac{2 μ g cos ( θ ) r}{( {R}_{1}^{2} + {R}_{2}^{2} )} , & Equation ( 37 ) \\ {α}_{manipulated} = \frac{2 μ g cos ( θ ) r}{( {R}_{1}^{2} + {R}_{2}^{2} ) + Δ {r}^{2}} . & Equation ( 38 )\end{matrix}$$

### Gravitational Moment Generating Torque

The chassis load induces a moment as it acts through a single point of each wheel, at its axis. This point, C, is shown on FIG. 22 and the moment about it is found using

M_{C}=gmΔr sin(θ). Equation (39)

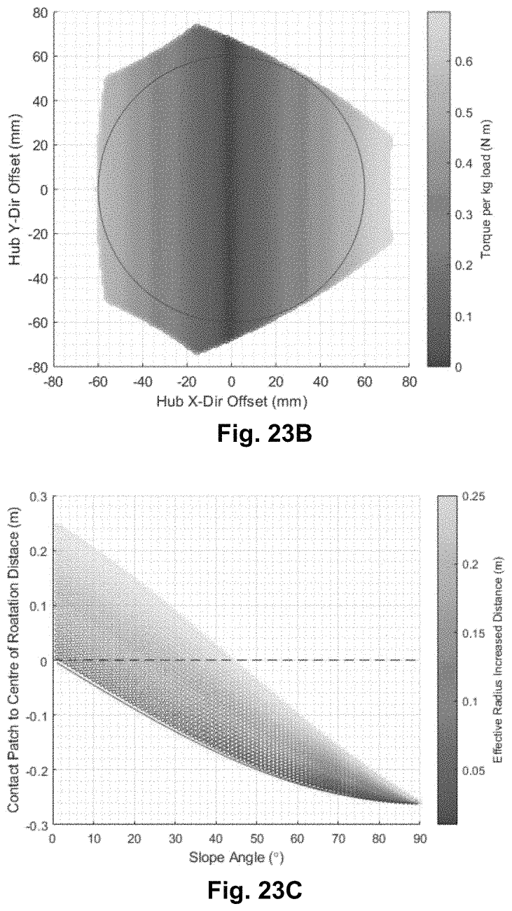

When the wheel is in its normal configuration Δr=0, all the forces act through the point C, therefore no moment is induced in the wheel. As Δr increases, a greater moment acts about point C, the different torque potential of different points is shown in FIG. 23B. The maximum rotation of the wheel due to M_{C} can also be calculated using

Rₘₐₓ=90°+θ,−90°<θ≤90°, Equation (40)

and the maximum distance the wheel can in turn travel using

$$D = 2 π r \times \frac{R}{360} . \qquad Equation ( 41 )$$

### Gravitational Energy

The gravitational potential energy, with respect to the ground, of the wheel can be calculated using

U=gmΔR_{y}, Equation (42)

where ΔR_{y} is known for each control point. Equations 39, 40, 41 show that when the hub is offset at θ=90°, the wheel benefits from highest potential energy, however the system is unstable. At this point the moment is zero, but a minor disturbance will cause the moment to greatly increase until the wheel preforms a rotation of 180° and looses its potential energy as the weight settles at the most stable point.

### Theoretical Traversable Slope Angle

The maximum traversable slope angle by pure use of gravity can be determined using trigonometry. Referring to FIG. 22, θ denotes the slope angle where θₘₐₓ is the maximum traversable slope angle calculated using

$${θ}_{max} = 90 - {tan}^{- 1} ( \frac{R}{Δ r} ) , \qquad Equation ( 43 )$$

where Δr is found by

Δr=\sqrt{Rₑ²−R²}. Equation (44)

The maximum traversable slope angle is then (θ_{MTSA})<θₘₐₓ. This calculation is shown in FIG. 23C for a number of wheels with different maximum Δr values, for comparison.

FIG. 22 shows point C as the true centre of the wheel, and the corresponding dashed red lines denote the cylinder positions to achieve this. Point D shows the manipulated position to generate moment M_{C} about point c. Cylinder positions for D are denoted by green dashed lines.

Centre Hub Workspace within the Wheel

The number of control pistons and their minimum and maximum reach directly impacts the wheel and the workspace available to the centre hub. The range of motion of the hub was found by generating a number of points and testing to determine if they were kinematically realisable. This allowed simple limit theory to determine the wheels workspace for specific piston configuration. A point lies within the workspace if it satisfies the following condition for all the pistons (i):

PRₘᵢₙ≤\vec{Pₗ}≤PRₘₐₓ,∀i, Equation (45)

where \vec{Pₗ} is the modelled piston vector spanning from Pᵢ to D, PRₘᵢₙ and PRₘₐₓ are the minimum and maximum reach of the pistons, respectively. The workspace points are then represented as a vector H_{W} of reachable x and y points. The calculated workspace is shown in FIG. 23A in blue. However, as the workspace has a reuleaux triangle shape, the minimum radius vector on the reuleaux triangle to the centre hub yields the radius of the usable rotational workspace of the wheel. This is shown in the green circle, and ensures any point within the green circle is kinematically realisable irrespective of wheel rotation.

### Experimental Validation

### Start-Up Gait

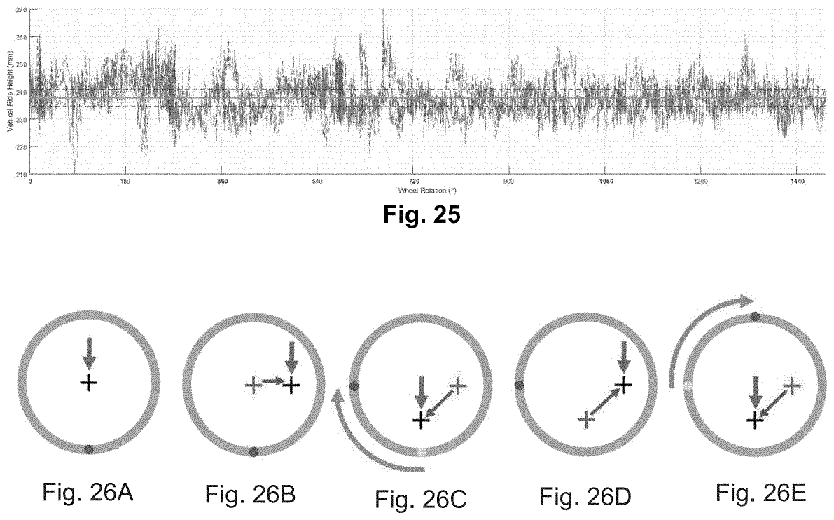

The start-up gait was required for all gaits in order to offset the centre hub from its geometric centre of rotation to a position able to generate torque and in doing so introduce energy into the system by making it positionally unstable. The magnitude of this lateral position change can be chosen depending on the amount of torque required to initiate rotation, torque able to be generated by each position is shown in FIG. 23B. FIG. 26(a) and FIG. 26(b) show this gait.

### Pump Gait

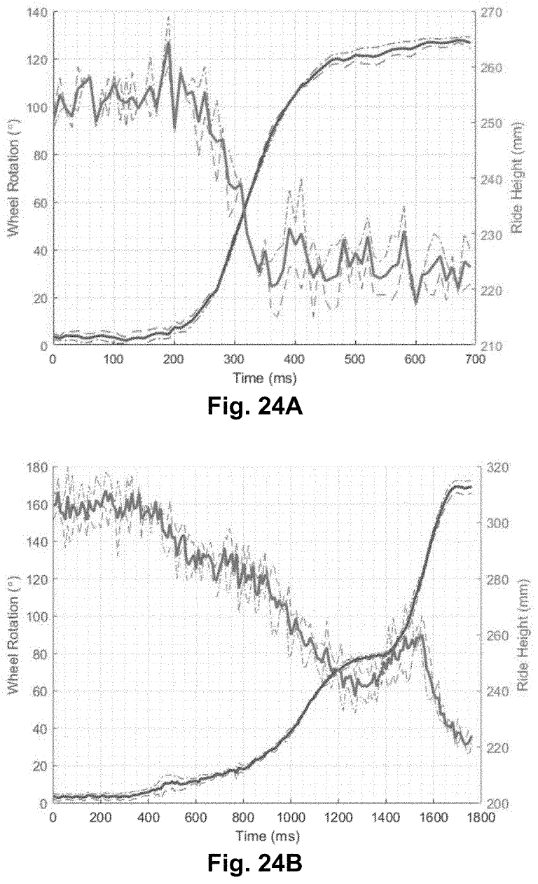

The pump gait consists of moving the centre of hub in the direction of desired motion, letting the wheel rotate due to gravity and settle, then moving the centre position again to repeat this rotation. This gait requires the start-up gait to first be performed then steps shown in FIG. 26(c) to FIG. 26(e) to be repeated to maintain a pump-like forward motion. The pump gait was used on flat terrain and tested for its performance on slopes. FIG. 24 shows the data from these experiments. FIG. 24A specifically shows this gait performed on a flat surface, and highlights the smooth relationship between the hub vertical position (ride height) and the rotation of the wheel. As the ride height is at its maximum (FIG. 26(b)) the system has the greatest potential energy due to gravity. Once rotation is initiated by actuation to an unstable state, the wheel turns and converts its ride height to angular velocity. When the ride height reaches its minimum (FIG. 26(c)), there is no gravitational energy left in the system, and it comes to a critically damped stop as the rotational energy is lost to friction.

TABLE 1
Slope angles and corresponding average velocity of the
wheel achieved during the experiments performed.

| FIG. | Slope (°) | Slope (%) | ω_{avg} (° s⁻¹) | V_{avg} (m⁻¹) |
|---|---|---|---|---|
| 4a | 0 | 0 | 428 | 2.278 |
| 4b | 3 | 5.24 | 142 | 0.756 |
| 4c | 5 | 8.75 | 123 | 0.655 |
| 4d | 8 | 14.05 | 50 | 0.266 |

FIGS. 24B, 24C and 24D show this same gate being used for slopes of 3°, 5° and 8° respectively. The relationship between wheel rotation and ride height in these figures is less smooth as FIG. 24A, due to extra forces acting on the system and a trade-off between local potential energy of the hub and the potential energy gain of the entire system as it climes the slope. The results also show the platform developing a lateral tilt, seen in the difference in ride height of the front and rear wheels, as it drives on the slope which in turn displaces the COG and the locomotion system becomes less efficient. Table 1 shows the slopes and angular velocities of the wheels achieved during the performed experiments.

### Sustained Driving Gait

The sustained driving gait is achieved by continuous centre hub adjustment to maintain a set ride height and generate forward motion of the wheel. Similarly to the pump gait it requires the start-up gait to be performed to introduce the initial energy and instability into the system that generates the initial rotation. However, rather than letting the wheel roll 90° before actuating again, this gait requires a more continuous control approach.

The gait requires continuous readjustment of the centre hub position so a set ride height is maintained. This gait as a result requires more energy to perform, however provides significantly smoother driving for the platform than the pump gait, as it maintains a set ride height. The period of control for the hub position depends on a number of factors. As the speed of rotation increases, the control frequency has to follow in order to maintain smooth driving. This can be set in the controller, that reads the wheel rotation and the ride height at high frequency, then determines if a new position is required based on the allowed ride height deviation.

The ride height of the wheel can be set to be lower or higher than its geometric centre of rotation, based on the amount of torque required. This can be done as the set ride height is directly proportional to the gravitational potential energy in the system, however the potential energy conversion into torque is controlled by the lateral position of the hub. The torque generated at each point in the hub workspace is shown in FIG. 23B.

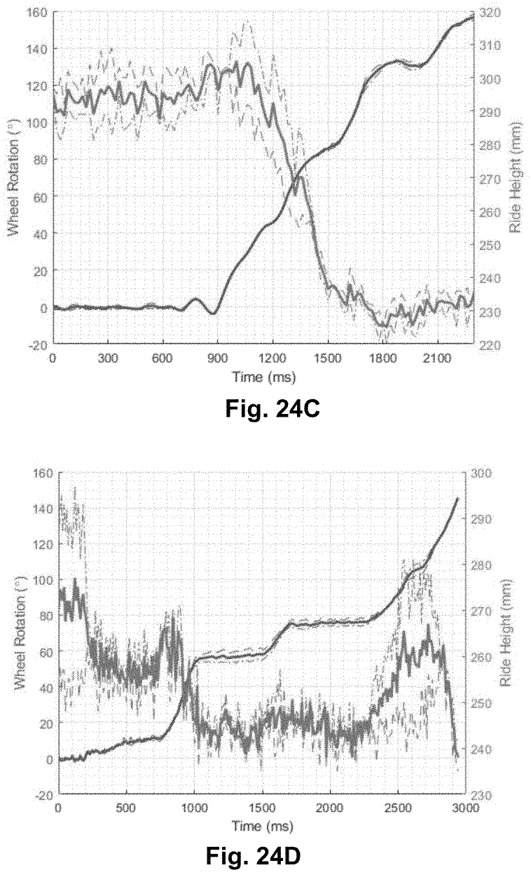

FIG. 25 shows the ride height data plotted verses rotation of the wheel recorded over an 8.5 metre drive. The figure shows a number of small disturbances on the ride height of the platform, with a standard deviation from the mean ride height of ±4.5 mm. Both the front and read wheel of the system maintained an acceptable ride height while generating locomotion over a sustained distance, validating that this is an effective locomotion system.

### Slope Angle

The theoretical maximum traversable slope angle calculated in the Theoretical Traversable Slop Angle paragraph and shown in FIG. 23C for this specific system, which was found to be 12°. Using the pump gait a maximum traversable slope angle of 8° was achieved in the experiments performed. This means that 67% of the theoretical angle was able to be achieved in practice before the system began experiencing difficulties in moving up the slope. The theoretical calculations assume a perfect world model, with no frictions and perfect actuator positions as well as perfect weight distribution. This is incorrect in the practical environment.

Friction between the wheel and surface and in the actuators contributed to a significant loss in energy, coupled with the less-than-perfect weight distribution and other losses in wheel bearings and minor errors in the control and position of the hub, all contributed to the physical performance of the system. Overall, the angles achieved are sufficient to prove this locomotion system is effective and provide sufficient performance for the envisioned applications.

Throughout this specification and claims which follow, unless the context requires otherwise, the word “comprise”, and variations such as “comprises” or “comprising”, will be understood to imply the inclusion of a stated integer or group of integers or steps but not the exclusion of any other integer or group of integers. As used herein and unless otherwise stated, the term “approximately” means ±20%.

It must be noted that, as used in the specification and the appended claims, the singular forms “a,” “an,” and “the” include plural referents unless the context clearly dictates otherwise. Thus, for example, reference to “a support” includes a plurality of supports. In this specification and in the claims that follow, reference will be made to a number of terms that shall be defined to have the following meanings unless a contrary intention is apparent.

It will of course be realised that whilst the above has been given by way of an illustrative example of this invention, all such and other modifications and variations hereto, as would be apparent to persons skilled in the art, are deemed to fall within the broad scope and ambit of this invention as is herein set forth.

1. A wheel including:
a) a substantially radially rigid rim;
b) a hub for mounting the wheel to an axle; and,
c) a plurality of actuators coupling the hub to the rim, the plurality of actuators being adjustable to control a hub position, the hub position being a position of the hub relative to the rim, and wherein at least some of the plurality of actuators act outside a plane of the rim.

2. The wheel according to claim 1, wherein the actuators include a first hub end coupled to the hub and a second rim end coupled to the rim, and wherein the at least some of the actuators include at least one of:
a) hub ends spaced in an axial direction, the axial direction being parallel to the axle; and,
b) rim ends spaced in the axial direction.

3. The wheel according to claim 2, wherein the actuators include a plurality of first actuators and a plurality of second actuators, wherein the first and second actuators have hub ends spaced in an axial direction.

4. The wheel according to claim 1, wherein the wheel includes a hub extending in an axial direction and wherein the actuators are coupled to the hub so that hub ends of at least some of the actuators are spaced in an axial direction.

5. The wheel according to claim 1, wherein the wheel includes two hubs connected to the rim relatively parallel to one another.

6. The wheel according to claim 5, wherein each hub is connected to three actuators.

7. The wheel according to claim 1, wherein the one or more actuators are pivotally mounted to the hub and the rim.

8. The wheel according to claim 7, wherein the one or more actuators are pivotally mounted to the hub and the rim using ball and socket joints.

9. The wheel according to claim 1, wherein each actuator includes a linear actuator having a housing and an arm linearly movable relative to the housing to allow a length of the linear actuator to be adjusted.

10. The wheel according to claim 9, wherein the housing includes a piston chamber and the arm is mounted to a piston movably mounted within the piston chamber to thereby adjust a length of the actuator.

11. The wheel according to claim 10, wherein each actuator further comprises a valve for controlling fluid flow into and out of the piston chamber to thereby adjust the length of the actuator.

12. The wheel according to claim 11, wherein the valve is a solenoid valve.

13. The wheel according to claim 1, wherein each actuator includes:
a) a sensor that measures an actuator arm position; and,
b) an actuator controller that controls the actuator in accordance with signals from the sensor and instructions from a control system.

14. The wheel according to claim 13, wherein the actuator controller:
a) uses signals from the sensor to determine a current actuator length; and,
b) controls the actuator in accordance with the current actuator length and a target actuator length.

15. The wheel according to claim 13, wherein the sensor includes a magnet mounted to an arm and an array of Hall effect sensors mounted to a housing, for determining an arm position of the arm relative to the housing, thereby allowing the actuator length to be measured.

16. The wheel according to claim 1, wherein the one or more actuators at least one of:
a) are electronic linear actuators and the sensor includes an encoder;
b) are mounted to the hub offset from the centre of the hub;
c) extend from the hub to the rim at angle offset to a radial direction; and,
d) are pivotally mounted to the hub and the rim.

17-19. (canceled)

20. The wheel according to claim 1, wherein the wheel includes three actuators.

21. The wheel according to claim 1, wherein the wheel includes a plurality of actuators evenly circumferentially spaced around the rim.

22. The wheel according to claim 1, wherein the hub position includes at least one of:
a) a position in a plane of the rim;
b) a position offset from the plane of the rim; and,
c) a rotation of the hub relative to a plane of the rim.

23-51. (canceled)
